(19) United States
(12) Patent Application Publication
(10) Pub. No.: US 2025/0059076 A1
(43) Pub. Date: Feb. 20, 2025

(54) SYSTEM AND METHOD FOR RECOVERY OF FERTILIZER BUILDING BLOCKS FROM WASTE

(71) Applicant: West Virginia University Board of Governors on Behalf of West Virginia University, Morgantown, WV (US)

(72) Inventors: Km Prottoy Shariar Piash, Morgantown, WV (US); Oishi Sanyal, Morgantown, WV (US); Lian-Shin Lin, Morgantown, WV (US); Rifat Anwar, Hoover, AL (US)

(21) Appl. No.: 18/782,115

(22) Filed: Jul. 24, 2024

Related U.S. Application Data
(60) Provisional application No. 63/519,369, filed on Aug. 14, 2023.
(60) Provisional application No. 63/634,989, filed on Apr. 17, 2024.

(51) Int. Cl. C02F 9/00; B01D 61/04; B01D 69/02; B01D 71/68; C01B 25/37; C01C 1/28; C02F 1/44; C02F 1/52; C02F 101/10; C02F 101/16; C05B 17/00; C05C 3/00

(52) U.S. Cl. CPC C02F 9/00; B01D 61/04; B01D 69/02; B01D 71/68; C01B 25/375; C01C 1/28; C05B 17/00; C05C 3/00; B01D 2315/08; B01D 2315/10; B01D 2325/04; B01D 2325/14; B01D 2325/16; B01D 2325/18; C02F 1/442; C02F 1/5245; C02F 2101/105; C02F 2101/16

(57) ABSTRACT

In one aspect, the disclosure relates to system for recovering ammonia and phosphorus from a waste stream, methods of using the system to precipitate phosphorus as vivianite and to separate ammonia from total organic carbon in the waste stream, methods of modifying a nanofiltration membrane to exhibit selectivity for ammonia passage relative to total organic carbon passage, and compositions including fertilizers produced using recovered ammonia, phosphorus, and optionally potassium from the waste stream. This abstract is intended as a scanning tool for purposes of searching in the particular art and is not intended to be limiting of the present disclosure.

### CROSS REFERENCE TO RELATED APPLICATIONS

This application claims the benefit of U.S. Provisional Application No. 63/519,369 filed on Aug. 14, 2023, and U.S. Provisional Application No. 63/634,989 filed on Apr. 17, 2024, each of which is incorporated herein by reference in its entirety.

### BACKGROUND

Ammonia (NH₃), phosphorus (P), and potassium (K)-based fertilizers play a vital role in agricultural production to meet the food demand for more than 3 billion people worldwide. The production processes of these critical substances are, however, energy-intensive and account for significant CO₂ emission. In particular, ammonia production via the conventional Haber-Bosch process accounts for ˜1.4% global CO₂ emission. Apart from ammonia, phosphorus and potassium are also essential micro-nutrients for the growth and yield of plants and crops. Raw materials for phosphorus- and potassium-based fertilizer are produced by mining different non-renewable rocks and mineral ores, and the mining processes also emit substantial amounts of CO₂. Meanwhile, excessive amounts of nutrients discharged to the environment from wastewaters can result in harmful algal blooms in receiving waters, causing adverse impacts on aquatic ecosystems, fisheries, recreation, water supplies, and public health. In a watershed, nutrient sources may be identified as a point of discharge (i.e., point sources) or diffuse in nature (i.e., nonpoint sources). Nutrient loads of effluents discharged from wastewater treatment plants represent a significant point source and can be reduced through nutrient recovery from the wastewaters. In particular, digestate waters from the anaerobic digestion (AD) processes have high ammonia (primarily as ammonium, NH₄⁺), phosphorus (P), and potassium (K) contents from which nutrients can be effectively recovered. The recovered nutrients can therefore be a sustainable alternative source that helps reduce energy consumption of fertilizer production and decarbonize the agricultural sector which is associated with 11-15% of total GHG emissions.

A developed nutrient recovery method for ammonium and phosphorus from concentrated wastewater involves chemical precipitation of struvite (MgNH₄PO₂·6H₂O) under alkaline conditions (pH 8.5-9.5). However, this approach requires pH-adjusting alkaline chemicals as well as Mg and P salts due to excessive NH₄⁺. There is currently no developed technology for recovering potassium (K⁺) from concentrated wastewater.

Vivianite (Fe₃(PO₄)₂·8H₂O) is a valuable product which has simple formation conditions and can be potentially used as a P fertilizer. Vivianite precipitation/crystallization has been observed in municipal wastewater treatment plants under circumneutral pHs and reducing environment and accounted for 40%-50% of total P precipitation in an iron-based removal process. Vivianite has slow oxidation kinetics and can be readily recovered by a magnet. Therefore, using vivianite precipitation could be a cost-effective method for P recovery from AD digestates. However, reaction conditions optimal for vivianite precipitation (e.g., pH and Fe/P stoichiometry) from digestate and their effects on minerology remain uninvestigated.

In addition to ammonium and phosphorus, AD digestates also contain a significant amount of organic carbon and therefore a technology that could selectively recover ammonium (as NH₃—N) while excluding organic carbon is preferred. In fact, recovering ammonium, phosphorus and potassium in separate products provides multifaceted benefits including flexibility in fertilization at an optimal N:P:K ratio that suites the soil and crops, and less nutrient losses to runoff. Membranes, via their size and charge-based exclusion mechanisms, could enable such separation. In addition, the energy consumption of membrane-based separation is significantly lower than other competing separation techniques. Membrane-based separation can also provide a sustainable approach to recover ammonium (NH₃—N) from organic carbon in a manner that requires no additional chemical dosing/pH adjustment. Previous studies have shown that nanofiltration (NF) membranes (e.g., NF270) can be used to recover ammonia from wastewater, however, the selective separation of ammonia from waste streams with high organic carbon content (measured in the form of total organic carbon, TOC) remains uninvestigated.

Usually, pH of the concentrated wastewater or digestate is close to 7 and recovering nutrients N, P, and K at this pH condition provides multifaceted benefits such as preservation of high nutrient contents when utilized in soil, no pH-changing chemical costs, etc. Alteration of pH increases soil toxicity under both acidic and basic pH conditions. Although limited research has been conducted to recover nutrients (N, P, K) by utilizing commercial NF membranes under both acidic and basic conditions, such membranes are not suitable at neutral pH conditions and therefore, rejects significantly high amounts of both NH₄⁺ and K⁺.

Despite advances in wastewater treatment research, there is still a scarcity of systems and methods for removing ammonium, phosphorus and potassium from waste streams which contains high organic carbon content. An ideal method would also enable facile and efficient recovery of valuable products, including vivianite, ammonium and potassium, following separation, without the need for additional chemical manipulation. An ideal method could further make use of commercially available membranes following surface modification rather than building entirely new devices, and could operate at neutral pH. These needs and other needs are satisfied by the present disclosure.

### SUMMARY

In accordance with the purpose(s) of the present disclosure, as embodied and broadly described herein, the disclosure, in one aspect, relates to system for recovering ammonium, phosphorus and potassium from a waste stream, methods of using the system to precipitate phosphorus as vivianite and to separate ammonium and potassium from total organic carbon in the waste stream, methods of modifying a nanofiltration membrane to exhibit selectivity for ammonia passage relative to total organic carbon passage, and compositions including fertilizers produced using recovered ammonia, phosphorus, and optionally potassium from the waste stream. The nutrients N, P, and K can be recovered at neutral pH, which can be advantageous as it preserves high nutrient contents for agricultural and other activities.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows an overall process diagram of vivianite precipitation and membrane separation for recovering phosphate (as vivianite) and ammonia (NH₃—N).

FIG. 2 shows a pKₐ versus (√I)/(1+√I) plot to determine solubility product of precipitated solid.

FIGS. 3A-3B show evolution of ferrous and phosphate forms with pH for Fe/P molar ratio (FIG. 3A) 2.1 and (FIG. 3B) 0.5 (right axis represents ammonia ion concentration).

FIG. 4A shows Fe(II) and P removal efficiency (%) from the aqueous phase of digestates for different Fe/P molar ratios at pH 7.0, and FIG. 4B shows P removal efficiency (%) for different Fe/P molar ratios and pH.

FIGS. 5A-5B show change in (FIG. 5A) Fe²⁺ and (FIG. 5B) PO₄³⁻ ion activity with Fe/P molar ratio at pH 7.0.

FIGS. 6A-6F show XPS Fe2P spectrum of solid precipitate obtained from synthetic digestate at Fe/P molar ratio of (FIG. 6A) 0.5, (FIG. 6B) 1.0, and (FIG. 6C) 2.1, and real digestate at Fe/P molar ratio of (FIG. 6D) 0.5, (FIG. 6E) 1.0, and (FIG. 6F) 2.1.

FIGS. 7A-7B show wastewater permeance and NH₃—N/TOC selectivity of commercial (FIG. 7A) NF270 membrane and (FIG. 7B) NF90 membrane at 50,100, and 150 psi. Experiments were performed using a dead-end filtration system at 25° C.

FIGS. 8A-8B show wastewater permeance and NH₃—N/TOC selectivity of NF270 membrane at 100 psi. FIG. 8A: Effect of NaCl on PDAC/SPS 5.5BL coated NF270 membranes. FIG. 8B: effect of outer layer on PDAC/SPS W NaCl coated NF270 membranes. Experiments were performed using a dead-end filtration system at 25° C.

FIG. 9 shows a schematic of a series-resistance model.

FIG. 10 shows NH₃ and TOC permeances of NF270, PDAC/SPS 5.5BL W NaCl coated NF270, and PDAC/SPS 5.5BL W NaCl (without NF270 backing layer). Permeances of the coating layer was estimated using the series-resistance model.

FIGS. 11A-11B show normalized flux ratio of PDAC/SPS 5.5BL W NaCl coated NF270 membrane at 100 psi for (FIG. 11A) synthetic digestate and (FIG. 11B) real digestate. Feed concentrations of run 1 and run 2 were similar 25° C.

FIG. 12 shows layer by layer deposition technique for fabricating polyelectrolyte multilayer membrane (adapted from Decher et al.).

FIG. 13 shows a schematic diagram of a crossflow filtration system.

FIGS. 14A-14E show precipitate from digestate with Fe/P molar ratio (FIG. 14A) 0.5, (FIG. 14B) 1.0, (FIG. 14C) 1.5, (FIG. 14D) 2.0, (FIG. 14E), 2.1.

FIGS. 15A-15B show SEM images of solid precipitate obtained from (FIG. 15A) synthetic digestate and (FIG. 15B) real digestate at Fe/P molar ratio of 2.1.

FIG. 16 shows overall wastewater permeability and NH₃/TOC selectivity of commercial and modified membranes at 100 psi (6.9 bar). Experiments were performed under dead-end filtration system at 25° C.

FIG. 17 shows chemical structures of different polyelectrolytes used in this study.

FIG. 18 shows intrinsic and extrinsic charge compensation of polyelectrolytes with or without presence of NaCl (adapted from Schlenoff et al.).

FIG. 19 shows an overall process diagram of one type of surface-modified polyelectrolyte multilayer membrane platform for separation of ammonium and potassium from organic pollutants. The platform includes a surface-modified membrane with high NH₄⁺/TOC and low NH₄⁺/K⁺ selectivity; Type 2: Surface-modified membrane with high NH4+/TOC and NH4+/K⁺ selectivity.

FIG. 20 shows an overall process diagram of one type of surface-modified polyelectrolyte multilayer membrane platform for separation of ammonium and potassium from organic pollutants. The platform includes a surface-modified membrane with high NH₄⁺/TOC and NH₄⁺/K⁺ selectivity.

FIG. 21 shows examples of molecular weight cutoffs for commercial NF270, type-1 (PDAC/SPS 5.5BL W NaCl Coated NF270) and type-2 (PAH/PAA xGlu 5.5BL Coated NF270) (cross-linked) membranes. Rejection tests were carried out using four different molecular weights' organic components: glycerol (˜92 g/mole), Glucose (˜180 g/mole), Polyethylene glycol (PEGs of ˜300 and 400 g/mole). Experiments were performed in duplicates and only average results were reported for these sets of membranes.

FIG. 22 shows exemplary mechanism of NH₄⁺ and K⁺ separation using covalently crosslinked polyelectrolytes.

FIG. 23 shows a vacuum filtration technique for developing polyelectrolyte multilayers on top of silica microparticles.

FIG. 24 shows an FTIR spectrum of glutaraldehyde crosslinked NF270[PAH(8.5)/PAA(3.5)]_{5.5}×GA and uncrosslinked NF270[PAH(8.5)/PAA(3.5)]_{5.5}×GA membrane.

FIG. 25 shows organic pollutant (TOC) rejection (%) of commercial and polyelectrolyte multilayer membranes.

FIG. 26 shows rejections of different molecular weight organic species for commercial NF270 and polyelectrolyte membranes.

FIG. 27 shows pH dependent ion rejections of NF270 membrane. Approximate rejection data for NH₄⁺, Cl⁻ and K⁺ were taken from Pronk et al., whereas surface charge data of NF270 and NF270[PDAC/SPS w NaCl]_{5.5} membrane were taken directly with permission from Sanyal et al. (Note that the surface charge values shown in the figure were obtained through streaming potential measurement).

FIG. 28A shows % permeance of nutrients for commercial and polyelectrolyte multilayer membranes. FIG. 28B shows zeta (ζ) potential of different polyelectrolyte multilayer coatings used in this study. Coating was applied on top of silica microparticles (ζ potential=−16.8±3.9 mV).

FIG. 29A shows nutrient/TOC selectivity of commercial NF270 and different PEM membranes, while FIG. 29B shows nutrient/TOC Permeability-Selectivity tradeoff curve for commercial and PEM membranes.

FIG. 30A shows intra-nutrient (ammonium/potassium) selectivity of commercial NF270 and different PEM membranes FIG. 30B shows performance of commercial NF270 and modified polyelectrolyte multilayer membranes when tested with binary ammonium-potassium mixture (left y-axis represents ammonium and potassium rejection (%), whereas right y-axis represents ammonium/potassium selectivity).

FIG. 31 shows variation of rejection performance of different batches of NF270 membrane (used as support layer for PEM membrane) purchased from Dupont Water Solutions (Edina, MN, USA).

FIG. 32 shows an FTIR Spectrum of commercial NF270 and NF270[PDAC/SPS w NaCl]_{5.5} membrane.

FIG. 33 shows NH₄⁺/organic pollutant permeance-selectivity tradeoff curve when tested with ternary mixtures of NH₄⁺, K⁺ and organic pollutant.

FIG. 34 shows K⁺/organic pollutant permeance-selectivity tradeoff curve when tested with ternary mixtures of NH₄⁺, K⁺ and organic pollutant.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

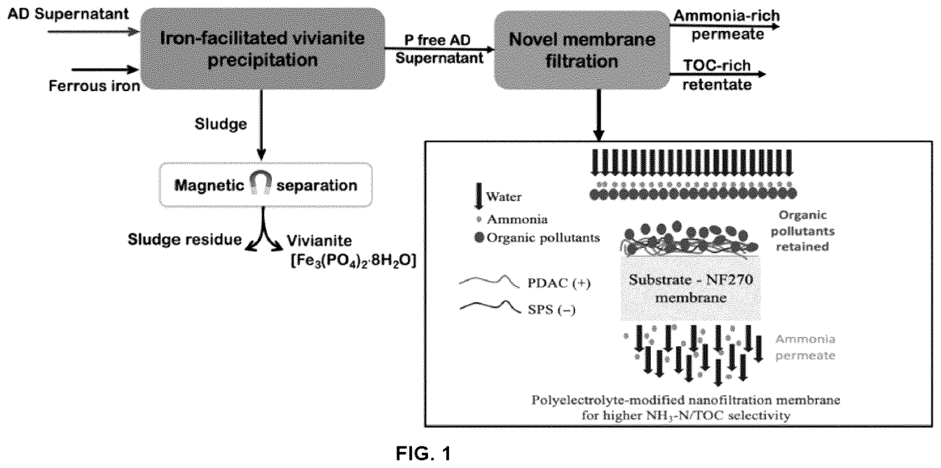

Disclosed herein is a hybrid method (FIG. 1) including vivianite precipitation and membrane filtration for the recovery of phosphorus and ammonia from both synthetic and real AD digestates. The study objective was to evaluate feasibility and quantify removal and separation efficiencies for nutrient recovery under a range of treatment conditions including pH, iron dosage, and membrane modification conditions. Visual Minteq 3.1 software was used to model chemical precipitation of vivianite and to help estimate solubility product constant of the solids. Spectroscopic analyses were used to examine the minerology of the chemical precipitates. Both the commercial and surface-modified membranes were tested under a dead-end filtration system from which the selectivity of ammonia over organics were calculated and compared. A series resistance model was then used to analyze the effect of poly-electrolyte coatings on surface-modified membranes, for selective separation of ammonia and organic carbon. Long term cross flow filtration experiments on both synthetic and real AD digestate were also performed to validate these results and to analyze the fouling propensities of these membranes.

System for Recovering Ammonia and Phosphorus from a Waste Stream

In one aspect, disclosed herein is a system for recovering ammonia and phosphorus from a waste stream, the system including at least the following two components:
(a) a first stage, wherein in the first stage, dissolved phosphorus is reacted with a ferrous salt to precipitate vivianite; and
(b) a second stage, wherein a nanofiltration membrane modified with one or more polyelectrolytes is present in the second stage for separation of ammonia.

Herein “ammonia” and “ammonium” are used interchangeably to refer to uncharged (NH₃) and charged (NH₄⁺) inorganic ammonia and/or ammonium species.

In some aspects, the system further includes a pre-filter to remove large particles from the wastes stream. In a further aspect, the filter can include a 0.45 μm polyethersulfone membrane.

In a further aspect, the system includes a means for separating and recovering the precipitated vivianite such as, for example, a filter, a magnet, or any combination thereof. In an aspect, the ferrous salt can be or include ferrous sulfate heptahydrate.

In another aspect, the second stage can be operated as a dead-end (batch) filter or a cross flow (continuous) filtration system.

In one aspect, the one or more polyelectrolytes can be or include poly(diallyl dimethylammonium) chloride (PDAC), poly(sodium 4-styrenesulfonate) (SPS), poly(allylamine hydrochloride) (PAH), poly(acrylic acid) (PAA), or any combination thereof. In some aspects, the membrane further includes sodium chloride in contact with the one or more polyelectrolytes. In any of these aspects, the one or more polyelectrolytes may be present on only a first side of the membrane.

In an aspect, the one or more polyelectrolytes can be PDAC and SPS in alternating layers. In a further aspect, an outermost layer of the alternating layers can be PDAC and can be positively charged, or is SPS and can be negatively charged. In an alternative aspect, the one or more polyelectrolytes can be PAH and PAA in alternating layers. Further in this aspect, the outermost layer can be PAH and can be positively charged. In a still further aspect, the outermost layer can be modified with glutaraldehyde to form a dense polyelectrolyte selective layer and reduce the effective porosity of the selective layer. In some aspects, surface charge analysis can be conducted and may show a negative surface charge.

In any of these aspects, the nanofiltration membrane can be constructed from a support fabric, a porous layer having a first side in contact with the support fabric, and a polymer coating in contact with a second side of the porous layer. In one aspect, the support fabric can be a nonwoven fabric. In another aspect, the porous layer can be made from or include polyethersulfone, polysulfone, or any combination thereof. In an aspect, the porous layer can be about 50 μm thick. In a further aspect, the polymer coating can be or include polypiperazine, polyamide, or any combination thereof, and can have a thickness of less than about 200 nm.

In one aspect, the system can be operated at a temperature of up to about 45° C. In a further aspect, this represents an advantage over current methods for production of ammonia, which require temperatures up to 400-500° C. and pressures of over 100 bar as in the Haber-Bosch process. In another aspect, the system can be operated at a pressure of up to about 41 bar, or can be operated at about 6.9 bar. In still another aspect, the system can be operated at a pH of from about 2 to about 11. In a further aspect, although the system can successfully operate in this pH range, operation at neutral pH allows for successful operation of the system and completion of the disclosed method and thus reduces the need for pH adjustment of the waste stream allows for operation of the system under milder conditions than those known for struvite precipitations.

Method for Recovering Ammonium and Phosphorus from a Waste Stream

In one aspect, disclosed herein is a method for recovering ammonium and phosphorus from a waste stream, the method including at least the steps of:
(a) contacting the system of any one of claims 1-26 with the waste stream;
(b) collecting precipitated vivianite from the first stage; and
(c) collecting ammonium that passes through the nanofiltration membrane.

Further in this aspect, the method can include anaerobically digested municipal sewage sludge. In one aspect, the waste stream includes from about 350 to about 685 mg/L of total ammonium, up to about 100 mg/L of total phosphorus, and from about 250 to about 750 mg/L of total organic carbon. In some aspects, in the disclosed method, the molar ratio of ferrous salt to total phosphorus in the waste stream can be about 2:1. In one aspect, substantially all of the phosphorus in the waste stream can be recovered using the disclosed system and method.

In one aspect, the method rejects at least about 75% of the total organic carbon in the waste stream, or at least about 85% of the total organic carbon in the waste stream. In another aspect, the method rejects less than about 50% of the total ammonium in the waste stream, or less than about 30% of the total ammonia in the waste stream. In a further aspect, the method recovers at least about 80% of the total ammonia in the waste stream. In some aspects, the method is at least about 3 times more selective for ammonia passage through the membrane than for TOC passage through the membrane, or is at least about 4.5 times more selective for ammonia passage through the membrane than for TOC passage through the membrane.

In some aspects, the membrane further recovers at least a portion of dissolved potassium in the waste stream. In one aspect, the method is at least about 1.25 times more selective for ammonium passage through the membrane than for potassium passage through the membrane. In any of these aspects, the method can recover at least about 70% of the dissolved potassium from the waste stream.

### Compositions Including Recovered Ammonium, Phosphorus, and Potassium

Also disclosed herein is a composition including ammonium, phosphorus, potassium, or any combination thereof recovered using the disclosed methods. In a further aspect, the composition can be or include a fertilizer.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a membrane,” “a waste stream,” or “an electrolyte,” include, but are not limited to, mixtures or combinations of two or more such membranes, waste streams, or electrolytes, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a ferrous salt refers to an amount that is sufficient to achieve the desired improvement in the property modulated by the formulation component, e.g. achieving the desired level of precipitation of phosphorus as vivianite from a waste stream. The specific level in terms of wt % in a composition required as an effective amount will depend upon a variety of factors including the amount of phosphorus in the waste stream, volume of water, other purifications method used in series with the precipitation, and other compounds present in the waste stream.

As used herein, the terms “optional” or “optionally” means that the subsequently described event or circumstance can or cannot occur, and that the description includes instances where said event or circumstance occurs and instances where it does not.

Unless otherwise specified, temperatures and pressures referred to herein are based on ambient temperature and atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### Aspects

The present disclosure can be described in accordance with the following numbered aspects, which should not be confused with the claims.

Aspect 1. A system for recovering ammonium and phosphorus from a waste stream, the system comprising:
(a) a first stage, wherein in the first stage, dissolved phosphorus is reacted with a ferrous salt to precipitate vivianite; and
(b) a second stage, wherein a nanofiltration membrane modified with one or more polyelectrolytes is present in the second stage for separation of ammonium.

Aspect 2. The system of aspect 1, further comprising a pre-filter to remove large particles from the waste stream.

Aspect 3. The system of aspect 2, wherein the filter comprises a 0.45 μm polyethersulfone membrane.

Aspect 4. The system of any one of aspects 1-3, further comprising a means for separating and recovering the precipitated vivianite.

Aspect 5. The system of aspect 4, wherein the means for separating and recovering the precipitated vivianite comprises a filter, a magnet, or any combination thereof.

Aspect 6. The system of any one of aspects 1-5, wherein the ferrous salt comprises ferrous sulfate heptahydrate.

Aspect 7. The system of any one of aspects 1-6, wherein the second stage operates as a dead-end or a cross flow membrane filtration system.

Aspect 8. The system of any one of aspects 1-7, wherein the one or more polyelectrolytes comprise poly(diallyl dimethylammonium) chloride (PDAC), poly(sodium 4-styrenesulfonate) (SPS), poly(allylamine hydrochloride) (PAH), poly(acrylic acid) (PAA), or any combination thereof.

Aspect 9. The system of any one of aspects 1-8, further comprising sodium chloride in contact with the one or more polyelectrolytes.

Aspect 10. The system of any one of aspects 1-9, wherein the one or more polyelectrolytes are present only on a first side of the membrane.

Aspect 11. The system of any one of aspects 8-10, wherein the one or more polyelectrolytes comprises PDAC and SPS in alternating layers.

Aspect 12. The system of aspect 11, wherein an outermost layer of the alternating layers comprises PDAC and is positively charged.

Aspect 13. The system of aspect 11, wherein an outermost layer of the alternating layers comprises SPS and is negatively charged.

Aspect 14. The system of any one of aspects 8-10, wherein the one or more polyelectrolytes comprises PAH and PAA in alternating layers.

Aspect 15. The system of aspect 14, wherein an outermost layer of the alternating layers comprises PAH and is positively charged.

Aspect 16. The system of aspect 14, wherein an outermost layer of the alternating layers is modified with glutaraldehyde to form a dense polyelectrolyte selective layer and decrease an amount of positive charge present on the outermost layer.

Aspect 17. The system of any one of aspects 1-16, wherein the nanofiltration membrane comprises a support fabric, a porous layer having a first side in contact with the support fabric, and a polymer coating in contact with a second side of the porous layer.

Aspect 18. The system of aspect 17, wherein the support fabric comprises a nonwoven fabric.

Aspect 19. The system of aspect 17 or 18, wherein the porous layer comprises polyethersulfone, polysulfone, or any combination thereof.

Aspect 20. The system of any one of aspects 17-19, wherein the porous layer has a thickness of about 50 μm.

Aspect 21. The system of any one of aspects 17-20, wherein the polymer coating comprises polypiperazine, polyamide, or any combination thereof.

Aspect 22. The system of any one of aspects 17-21, wherein the polymer coating has a thickness of less than about 200 nm.

Aspect 23. The system of any one of aspects 1-22, wherein the system is operated at a temperature of up to about 45° C.

Aspect 24. The system of any one of aspects 1-23, wherein the system is operated at a pressure of up to about 41 bar.

Aspect 25. The system of aspect 24, wherein the system is operated at a pressure of about 6.9 bar.

Aspect 26. The system of any one of aspects 1-25, wherein the system is operated at a pH of from about 2 to about 11.

Aspect 27. A method for recovering ammonium and phosphorus from a waste stream, the method comprising:
(a) contacting the system of any one of aspects 1-26 with the waste stream;
(b) collecting precipitated vivianite from the first stage; and
(c) collecting ammonium that passes through the nanofiltration membrane.

Aspect 28. The method of aspect 27, wherein the waste stream comprises anaerobically digested municipal sewage sludge.

Aspect 29. The method of aspect 27 or 28, wherein the waste stream comprises from about 350 to about 685 mg/L of total ammonium.

Aspect 30. The method of any one of aspects 27-29, wherein the waste stream comprises up to about 100 mg/L of total phosphorus.

Aspect 31. The method of aspect 30, wherein a molar ratio of ferrous salt to total phosphorus is about 2:1.

Aspect 32. The method of any one of aspects 27-31, wherein the method recovers substantially all of the phosphorus in the waste stream.

Aspect 33. The method of any one of aspects 27-32, wherein the waste stream comprises from about 250 to about 750 mg/L of total organic carbon.

Aspect 34. The method of any one of aspects 27-33, wherein the method rejects at least about 75% of the total organic carbon in the waste stream.

Aspect 35. The method of aspect 34, wherein the method rejects at least about 85% of the total organic carbon (TOC) in the waste stream.

Aspect 36. The method of any one of aspects 27-35, wherein the method rejects less than about 50% of the total ammonium in the waste stream.

Aspect 37. the method of aspect 36, wherein the method rejects less than about 30% of the total ammonium in the waste stream.

Aspect 38. The method of any one of aspects 27-37, wherein the method recovers at least about 80% of the total ammonium in the waste stream.

Aspect 39. The method of any one of aspects 27-38, wherein the method is at least about 3 times more selective for ammonium passage through the membrane than for TOC passage through the membrane.

Aspect 40. The method of aspect 39, wherein the method is at least about 4.5 times more selective for ammonium passage through the membrane than for TOC passage through the membrane.

Aspect 41. The method of any one of aspects 27-40, wherein the membrane further recovers at least a portion of dissolved potassium in the waste stream.

Aspect 42. The method of aspect 41, wherein the method is at least about 1.25 times more selective for ammonium passage through the membrane than for potassium passage through the membrane.

Aspect 43. The method of aspect 41 or 42, wherein the method recovers at least about 70% of the dissolved potassium from the waste stream.

Aspect 44. A composition comprising ammonium, phosphorus, potassium, or any combination thereof recovered using the method of any one of aspects 27-43.

Aspect 45. The composition of aspect 44, wherein the composition comprises a fertilizer.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Integrating Chemical Precipitation and Membrane Separation for Phosphorus and Ammonia Recovery from Anaerobic Digestate

### Materials and Methods

Materials. Poly(diallyl dimethylammonium) chloride (PDAC, 20 wt % in H₂O), poly(sodium 4-styrenesulfonate (SPS, MW˜70,000 g/mol), and sodium chloride (NaCl, 99% w/w) were purchased from Sigma-Aldrich. Two commercial NF membranes, NF90 and NF270, were purchased from DuPont Water Solutions (MN). NF270 was used as the support for fabricating surface-modified polyelectrolyte multilayer membranes. Sodium phosphate monobasic (NaH₂PO₄·2H₂O), ammonium chloride (NH₄Cl), sodium acetate anhydrous (C₂H₃NaO₂), ethanol (C₂H₆O), lactose monohydrate (C₁₂H₂₂O₁₁·H₂O), and ferrous sulfate heptahydrate were purchased from HACH (Loveland, Colorado).

Preparation of synthetic digestate. A literature review was conducted on the composition of digestate from anaerobic digestion of municipal sewage sludge (Table 1). The data showed large variations in TOC, NH₃ and P concentrations. These variations were attributed to differences in the wastewater and sludge composition, as well as treatment processes used at the different treatment plants. In this study, synthetic digestates containing these major constituents were used (Table 2). The synthetic digestate solutions were prepared using sodium phosphate monobasic (NaH₂PO₄·2H₂O, 0.6 mmol/L or mM), ammonium chloride (NH₄Cl, 11.2 mM), sodium acetate anhydrous (C₂H₃NaO₂, 12.2 mM), ethanol (C₂H₆O, 0.17 ml/L), and lactose monohydrate (C₁₂H₂₂O₁₁·H₂O, 2.8 mM). Ferrous sulfate heptahydrate was used as the iron source for chemical dosing. The real digestate samples were first filtered with 0.45 μm polyethersulfone membrane to remove large, suspended particles and microorganisms before using them for P and NH₃ separation.

TABLE 1
Characterization of supernatant from AD of waste activated sludge

| | Ammonium | Phosphate |
|---|---|---|
| Sources | (mg/L) | (mg/L) |
| Municipal sewage treatment plant, | 370 | 190 |
| Beijing, China | | |
| Domestic wastewater treatment plant | 273 | 168 |
| in Melbourne, Australia | | |
| Wastewater treatment plant in Queensland, | 328 | 150 |
| Australia | | |
| Sewage treatment plant in Fukuoka City, | 756 | 207 |
| Japan | | |
| Sewage treatment plant in Australia | 775 | 293 |
| Wastewater treatment plant in Adelaide, | 643 | 235 |
| Australia | | |
| Wastewater treatment plant in Italy | 914 | 139 |
| Wastewater treatment plant in Japan | 441-602 | 198-290 |

TABLE 2
Chemical compositions of synthetic solution
and real AD digestate used in this work

| Parameter | Real digestate | Synthetic digestate |
|---|---|---|
| Total NH₃ (mg/L) | 350-685 | 685 |
| Total P (mg/L) | 100 | 100 |
| TOC (mg/L) | 250-750 | 750 |

Vivianite precipitation for P recovery: ferrous dosing and pH effects. Predetermined amounts of ferrous (0.07-7 mM) were added to 1 L of the synthetic digestate to obtain Fe/P molar ratios ranging from 0.02 to 2.1, while phosphate concentration was kept at 3 mM. For each Fe/P molar ratio, three batch reactors (1 L glass bottles) conditioned to pH 6.5, 7, and 7.5 with a NaOH solution (0.5 N) were used to study the pH effects. The bottles were sealed immediately after the ferrous addition. These bottles were then placed in a shaker for 5 min, followed by 30 min without mixing to allow continued chemical precipitation. Each solution was then filtered through a polyethersulfone membrane (0.45 μm) and the aqueous Fe(II) and phosphate concentrations of the filtrate were measured. The filtered solids were collected for spectroscopic analyses. TOC analysis was also done before and after chemical precipitation.

Estimation of solubility product (Kₛₚ) of precipitated solid. Thermodynamic solubility product (Kₛₚ) of the precipitated solids was determined by extrapolating the solubility products at non-zero ionic strengths to standard state of zero ionic strength.

The solubility product of vivianite,

$${K}_{sp} = {( \text{?} )}^{3} {( \text{?} )}^{2} {K}_{c} . \qquad ( 1 )$$

$$\text{?} \text{indicates text missing or illegible when filed}$$

where K_{c} is the experimentally determined solubility product and was calculated as [Fe²⁺]₃[PO4³⁻]₂ (where [ ] denotes molar concentration). In Equation 1, Y⁻ denotes the activity coefficient and was estimated following the Guntelberg approximation of the Debye-Huckel limiting law

$$log \text{?} = - A \text{?} \frac{\sqrt{I}}{1 + \sqrt{I}} \qquad ( 2 )$$

$$\text{?} \text{indicates text missing or illegible when filed}$$

where I is the ionic strength (mol/L). Combining Equations (1) and (2) gives the following relationship:

$$- log {K}_{c} = - log {K}_{sp} - {A}^{′} \frac{\sqrt{I}}{1 + \sqrt{I}} \qquad ( 3 )$$

where A′=3z²Fe²⁺+2z²PO₄³⁻; pKₛₚ or −log Kₛₚ can be determined from the intercept of the fitted line of the plot of −log K_{c} versus (√I)/(1+√I) at I=0.

To obtain different values of K_{c} and ionic strength (I) or developing a plot for the Kₛₚ estimation (Equation 3), the measured Fe(II) and phosphate concentrations from the batch vivianite precipitation experiments for pH 7 were used. Visual Minteq 3.1 (KTH, Sweden, 2013) was used to determine Fe²⁺ and PO₄³⁻ activities from the measured concentrations. The ionic activity (I) was determined using Equation 4. The data points from the −log K_{c} versus (√I)/(1+√I) graphs were used for linear extrapolation to determine the value of pK_{c} at I=0.

$$I = \frac{1}{2} [ {C}_{Fe} * {{Z}^{2}}_{Fe} + {C}_{{PO}_{4}} * {{Z}^{2}}_{{PO}_{4}} ] \qquad ( 4 )$$

where C is the molar concentration of ferrous/phosphate, which was calculated as added concentration subtracted by the filtrate concentration, and Z is the charge number.

Membrane filtration. The digestates after chemical precipitation and solid removal were used in batch (dead-end) and continuous (cross flow) membrane filtration for liquid ammonia recovery.

Preparation of polyelectrolyte membranes. Layer by layer (LbL) dip coating experiments were performed on the sur-face of NF270 membrane using the alternative layers of PDAC (+) and SPS (−) as described by Sanyal et al. Prior to LbL deposition, the NF270 membrane substrates were soaked in DI water overnight. Prior to the LbL experiments, four alternate sheets of parafilm and aluminum foil were used to cover the permeate sides of the membranes to prevent the deposition of polyelectrolytes on the permeate side. Polyelectrolyte solutions were prepared at a concentration of 10 mM by dissolving each polyelectrolyte in 18.2 MΩ DI water with and without 0.5 M NaCl. The covered membrane sample was dipped in PDAC solution for 10 min followed by three DI water washing steps for 2+2+1 min. Subsequently, the membrane was dipped in SPS for 10 min, followed by the same three DI water washing steps. This process of dipping in alternate PDAC and SPS polyelectrolytes was repeated for 5 or 5.5 cycles, resulting in 5/5.5 bilayer (BL) surface modified membranes ending with negatively charged SPS or positive charged PDAC respectively. On completion of the LbL process, a required portion of the membrane was cut out and dipped in DI water overnight, prior to the filtration tests.

LbL-modified membranes with several different polyelectrolyte compositions were developed in this work.

Set 1—(PDAC/SPS 5BL W NaCl coated NF270): 5 bilayers of PDAC and SPS (both in 0.5 M NaCl) were deposited on NF270 substrate, therefore ending with a negatively charged (SPS) outermost layer. Note that in some aspects of this disclosure, this membrane was also designated as “NF270[PDAC/SPS w NaCl]₅”.

Set 2—(PDAC/SPS 5.5BL W NaCl coated NF270): 5.5 bilayers of PDAC and SPS (both in 0.5 M NaCl) were deposited on NF270 substrate, therefore ending with a positively charged (PDAC) outermost layer. Note that in some aspects of this disclosure, this membrane was also designated as “NF270[PDAC/SPS w NaCl]_{5.5}”.

Set 3—(PDAC/SPS 5.5BL W/O NaCl coated NF270): 5.5 bilayers of PDAC and SPS (both in pure DI without NaCl) were deposited on NF270 substrate, therefore ending with a positively charged (PDAC) outermost layer. Note that in some aspects of this disclosure, this membrane was also designated as “NF270[PDAC/SPS w/o NaCl]_{5.5}”.

Dead-end filtration setup. A HP 4750 stirred dead-end membrane permeation cell (Sterlitech, Kent, Washington) system was used for the preliminary experiments. The volume of this filtration system is ˜300 mL and the effective membrane filtration area is ˜14.6 cm². A nitrogen cylinder was used to pressurize the water/solution across the membrane, providing the effective driving force. The filtration system was placed over a magnetic stirring plate, and the solution was stirred throughout the entire duration of the experiment to reduce concentration polarization effects. Before testing with synthetic digestate, pure DI water was run through the membranes at 100 psi until the flux became constant, from which pure water permeance was calculated. For synthetic digestate, flux and permeance were recorded after collecting 60 mL permeate. All dead-filtration experiments were performed in triplicates and the results reported represent an average of three samples along with standard deviations.

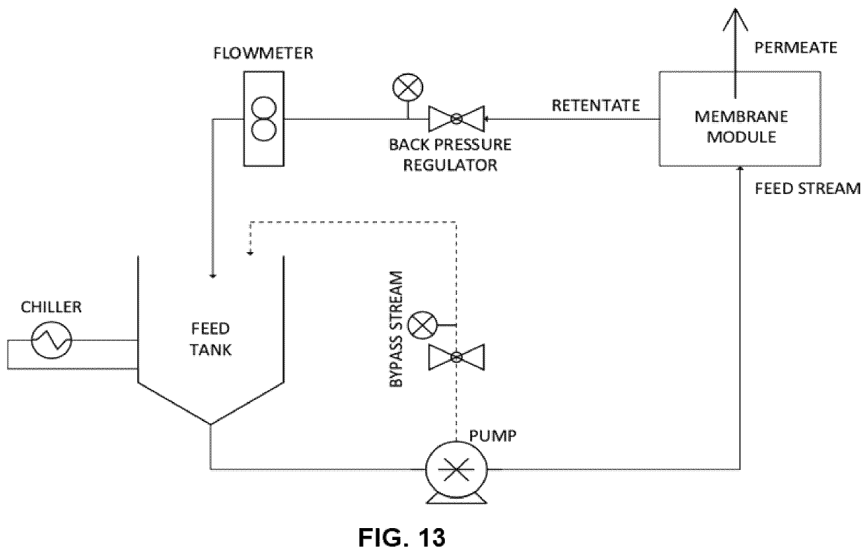

Cross flow filtration setup. A CF 042 cross flow unit (Sterlitech, Kent, Washington) was used for analyzing the long-term performances and determining the fouling behavior of modified polyelectrolyte membranes. The effective surface area of the cross flow system is around 42 cm². A positive displacement pump was used to transfer the feed sample from conical feed tank (˜19 L) to mem-brane module. A portion of the feed stream was divided and recycled back to the feed tank through a bypass needle valve. For controlling the pump speed, a variable speed controller was used. Temperature of the feed solution was controlled through a digital chiller (Polysciences, Inc.). Transmembrane pressure between membrane modules was controlled by adjusting a control valve connected to the retentate site as well as a bypass needle valve connected to the feed site. Retentate stream flow rate was measured using a Site Read Panel Mount Flowmeter connected to the retentate line. A closed circuit filtration experiment was performed from which both the retentate and permeate streams were recycled back to the feed tank. All the components of the cross flow setup was bought from Sterlitech, Kent, Washington and assembled in the lab. The detailed diagram for this setup is shown in FIG. 13.

Membrane transport property evaluation. Water permeance was calculated by using the following equation:

$$P = \frac{{J}_{W}}{Δ P} \qquad ( 5 )$$

Here, P is the water permeance (L/m2 h bar or LMH/bar); JW is the water flux (L/m² h or LMH) calculated using the volumetric flow rate (L/h) over effective filtration area (m2); and ΔP is the transmembrane pressure difference (bar).

Rejection (%) was calculated by using the following equation:

$$R = \frac{{C}_{avg} - {C}_{P}}{{C}_{avg}} \times 100 \% \qquad ( 6 )$$

$$where$$

$${C}_{avg} = \frac{{C}_{F} + {C}_{R}}{2} \qquad ( 7 )$$

Here, C_{F} is the sample feed concentration (mg/L); C_{R} is the sample retentate concentration (mg/L); and C_{P} is the sample permeate con-centration (mg/L).

Selectivity of ammonia (NH₃) over TOC was determined by using the following equation:

$${S}_{{NH}_{3} - N / TOC} = \frac{\frac{{C}_{P , {NH}_{3}}}{{C}_{P , TOC}}}{\frac{{C}_{F , {NH}_{3}}}{{C}_{F , TOC}}} \qquad ( 8 )$$

Here, C_{P,NH3} is the concentration of ammonia in permeate stream (mg/L); C_{P,TOC} is the concentration of total organic carbon in permeate stream (mg/L); C_{F,NH3} is the concentration of ammonia in feed stream (mg/L); and C_{F,TOC} is the concentration of total organic carbon in feed stream (mg/L).

Water and mineral analyses, and thermodynamic modeling. The phosphate concentration of the solutions were determined using an ascorbic acid method (Standard Method 4500 E; Rodger et al.). Ferrous iron concentration was measured using the 1,10 phenanthroline method (Standard Method 3500 B). The ammonium (NH₄⁺) concentration was measured using a phenol method with a UV/Vis spectrophotometer (Perkin Elmer 3100). TOC concentration was measured by using a total organic carbon analyzer (Shimadzu TOC-L series). Solids collected from the filtration (i.e., chemical precipitates) were analyzed to characterize the morphology and chemical composition using a scanning electron microscope equipped with an energy dispersion spectroscopy (SEM-EDS, Hitachi S 4700). A closed desiccator filled with calcium sulfate and flushed with N₂ gas was used to dry out the precipitated solid while avoiding oxidation. The dried solids were ground and mounted on aluminum stubs and then coated with Au—Pd using a sputter (Denton Desk V) to avoid surface charging. An accelerating voltage of 10.0 KV was used for SEM analysis. Elemental analysis was conducted using EDS spectrometry under an accelerating voltage of 15 kV. In addition, X-ray photoelectron spectroscopy (XPS, PHI 5000 Versaprobe) analysis was used to determine the chemical states of Fe and P in the powdered solid precipitate mounted on a sample holder with a zero reflective quartz plate. A monochromatized Al Kα X-ray source (1487 eV) was used to obtain XPS spectra while the base pressure in the analytical chamber was maintained on the order of 10⁻⁷ Pa. Thermodynamic evaluations were conducted with Visual Minteq to study the stable minerals that can be formed with availability of Fe²⁺,PO₄³⁻, and NH₄⁺ as major ions that represent the digestate environment with the ferrous dosage. The presence of organics was not considered in thermodynamic evaluation as their interference has not been observed during solid precipitation.

### Results and Discussion

Herein, the factors involved in vivianite precipitation that led to optimum phosphorus recovery as well as the role of the membrane selective layer chemistry in achieving high NH₃—N/TOC selectivities are analyzed. At first, digestates (containing P, NH₃, TOC) were treated with ferrous iron to recover phosphorus as vivianite. No observable change in TOC level was found after chemical precipitation. The filtrate (P-free digestates) was then tested in a batch (dead-end) and continuous (cross flow) membrane filtration system for ammonia recovery.

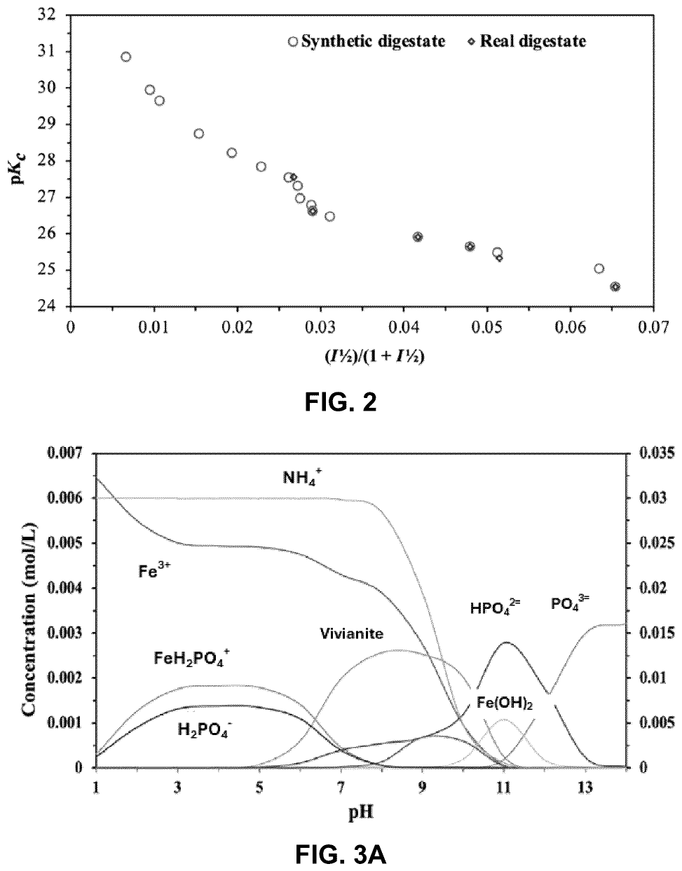

Phosphorus recovery using vivianite precipitation: Thermodynamic analysis. Solubility product (Kₛₚ): The pK_{c} values of the precipitated solid showed almost a linear relationship (R²=0.88) with [^{I0.5}/(1+I^{0.5})] for the range of Fe/P molar ratio 0.02-2.1 (FIG. 2). The determined value of pKₛₚ, intercept of pK_{c} versus [I^{0.5}/(1+I^{0.5})], was 32.96, which is consistent with the reported pKₛₚ value of vivianite in the literature (Table 3). This suggests that vivianite was the main mineral of the precipitated solids from the ferrous dosing to the synthetic digestate. The data points obtained from ferrous dosing to the real digestate samples were in line with the points for the synthetic digestate. The agreement of the two data sets suggests vivianite precipitation as the predominant chemical reaction for both the synthetic and real digestate samples, and the presence of other divalent cations (e.g., Ca²⁺, Mg²⁺) in the field-collected digestate did not affect vivianite solubility product in a significant way.

TABLE 3
pKₛₚ values of vivianite reported in literature

| pKₛₚ | Reference |
|---|---|
| 29.9 | Singer, PC (1972) |
| 35.4 | Rosenqvist, IT (1970) |
| 35.7 | Al-Borno, A. et al (1994). |
| 29 | Pei-Jen, C. et al (1974) |

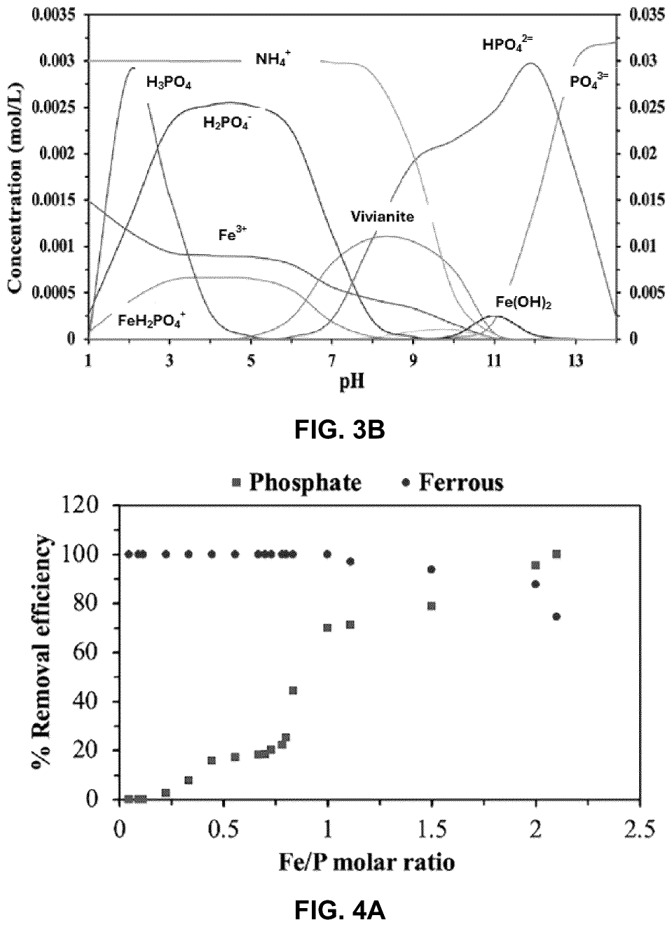

Effects of pH and ferrous dosage on P recovery. Thermodynamic modeling using the Visual Minteq 3.1 software indicated that with Fe²⁺,PO₄³⁻, and NH₄⁺ availability for Fe/P=0.5 and 2.1, vivianite was the major precipitated solid under pH from 6.5 to 9.0, while ferrous hydroxide precipitation occurred along with vivianite under higher pH (FIGS. 3A-3B). The model results indicated that Fe²⁺ and PO₄³⁻ ions played a major role in precipitation with no interference from NH₄⁺ up to pH 10.0. A previous study reported that pH ranging from 6 to 8 was conducive to vivianite precipitation, which is consistent with the model results of this study.

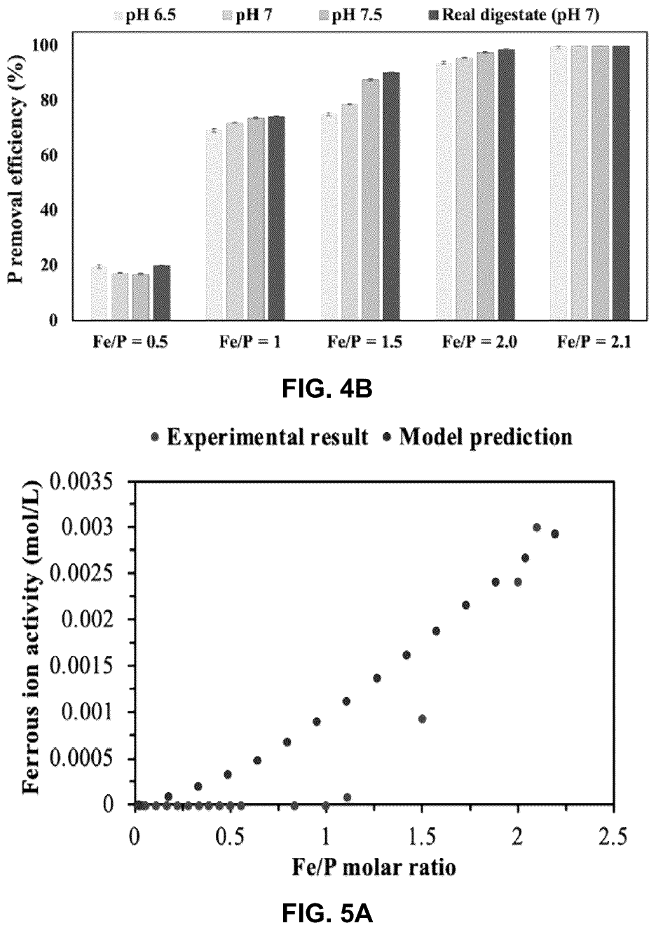

P removal/recovery from the digestates were low for Fe/P molar ratio of <0.5 (FIG. 4A). Similar P removal/recovery trends with Fe/P ratio were observed for synthetic and real digestates, increasing from 17% to 20% for ratio 0.5%-100% for ratio 2.1 (FIG. 4B). Except for Fe/P=0.5, P removal increased with pH. However, this pH effect on P recovery became insignificant for molar ratio 2.1 (FIG. 4B). This indicates that with sufficiently high Fe/P ratio (i.e., ≥2), there is no need of raising the pH for chemical precipitation of P. Such characteristics of vivianite precipitation makes it unnecessary to raise the pH for chemical precipitation as in the case of struvite and significantly reduces the chemical cost. The optimal Fe/P molar ratio (2.1) for chemical precipitation and recovery of P exceeded stoichiometric Fe/P molar ratio for vivianite (1.5), which suggests probable co-precipitation of other Fe minerals. Such phenomenon has been observed in chemical precipitation of vivianite due to oxidation of Fe(II) to Fe(III) and thus coprecipitation of ferric minerals along with vivianite.

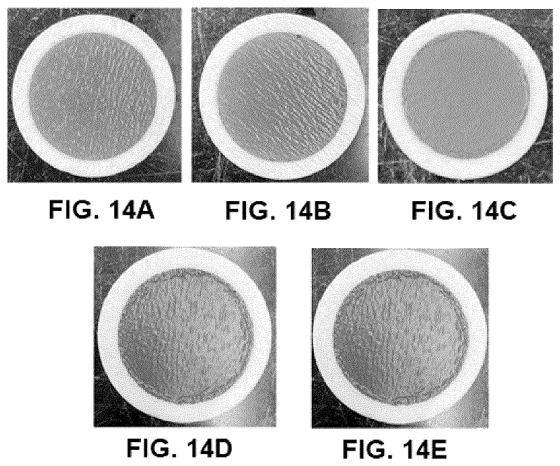

Effects on mineralogy of precipitated solids. The color of the precipitated solids was observed to vary with ferrous dosage (FIGS. 14A-14E). At circumneutral pHs, ferric minerals can also precipitate due to ferrous oxidation if a strict anaerobic condition is not maintained during ferrous dosage. Various Fe precipitation reactions could occur in such an environment depending on Fe oxidation state and solubility products of the Fe minerals (Table 4). For instance, formation of ferric hydroxide and goethite are thermodynamically favored over vivianite due to lower Kₛₚ (Table 4). The light brown color of the precipitated solid obtained at the lower Fe/P molar ratios (0.5 and 1.0) also suggest probable coprecipitation of brownish yellow Fe minerals (e.g., ferric hydroxide/goethite) along with vivianite. How-ever, at the higher Fe/P molar ratios (2 and 2.1), the bluish green color indicates vivianite precipitation as major solid (FIGS. 14A-14E). At the higher Fe/P molar ratios, vivianite formation probably became kinetically favored over thermodynamically favored ferric minerals.

TABLE 4
Kₛₚ values of different Fe minerals

| Minerals | Kₛₚ |
|---|---|
| Goethite [FeOOH] | 10^{-42.97} |
| Ferric hydroxide [Fe(OH)₃] | 10^{-38.55} |
| Vivianite [Fe₃(PO₄)₂•8H₂O] | 10⁻²⁹ to 10^{-35.7} |
| Ferric phosphate [FePO₄] | 10⁻²² |
| Ferrous hydroxide [Fe(OH)₂] | 10⁻¹⁷ |
| Ferric oxide [Fe₂O₃•0.5H₂O] | 10^{-4.89} |

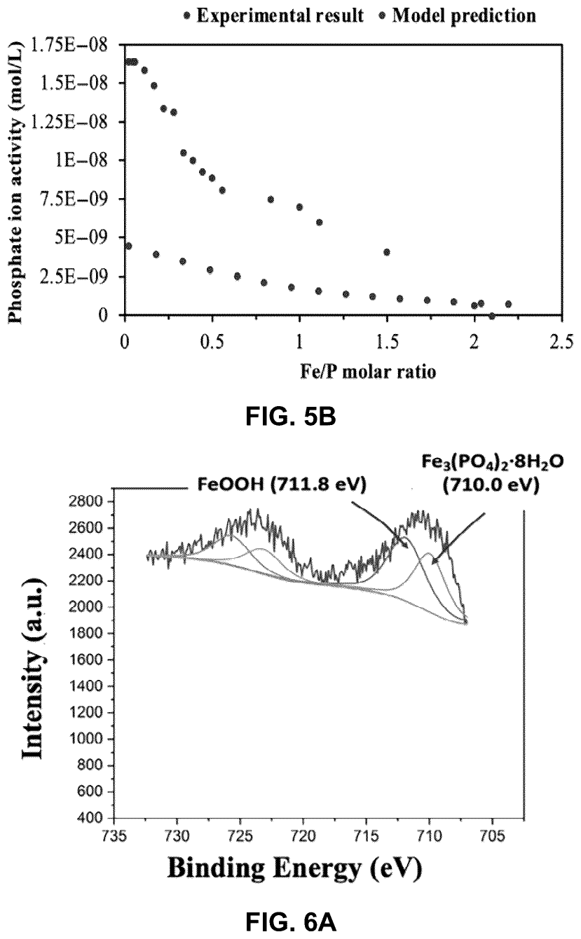

Our analysis of Fe²⁺ and PO₄³⁻ activities also indicates possibility of ferric mineral coprecipitation at the lower Fe/P molar ratios. FIGS. 5A-5B show change in Fe²⁺ and PO₄³⁻ activities with increasing ferrous dosage as predicted by the thermodynamic model and as observed in experimental results. For lower Fe/P molar ratio (<1), this analysis showed significantly lower and higher Fe²⁺ and PO₄³⁻ activities, respectively compared with the model prediction (FIGS. 5A-5B). However, model and experimental results converge at Fe/P molar ratio 2. The Minteq modeling determined Fe²⁺ and PO₄³⁻ activities considering vivianite as the major precipitation reaction, and probable coprecipitation of ferric minerals were not evaluated. Thus, the model determined Fe²⁺ and PO₄³⁻ activities changed linearly with ferrous dosage, however the linear pattern was only observed in experimental data for higher Fe/P molar ratios (2 and 2.1) (FIGS. 5A-5B). At lower Fe/P molar ratios, higher Fe(II) consumption and lower P consumption in experimental results compared with model prediction may be attributable to coprecipitation of ferric minerals along with vivianite. Good agreement between the experimental and modeling results for higher Fe/P molar ratios (2 and 2.1) indicates the probability of vivianite being the major precipitate under such conditions.

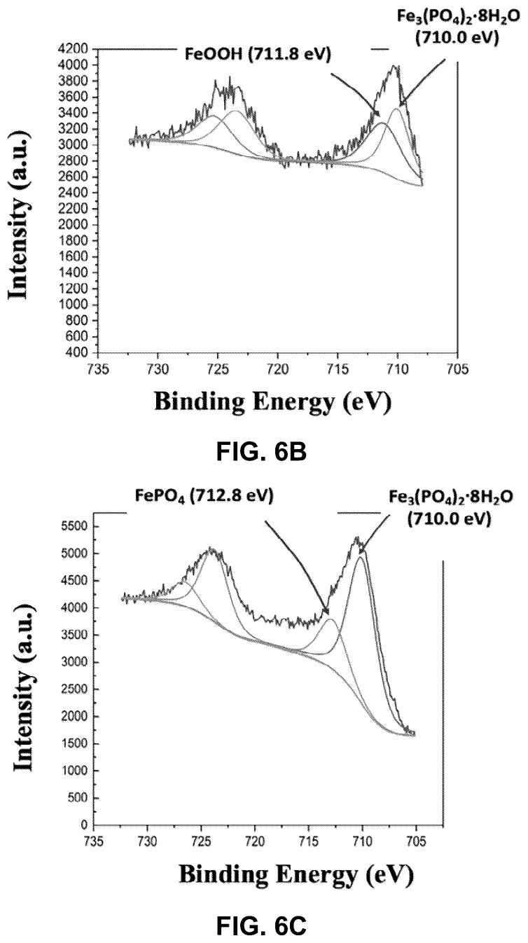

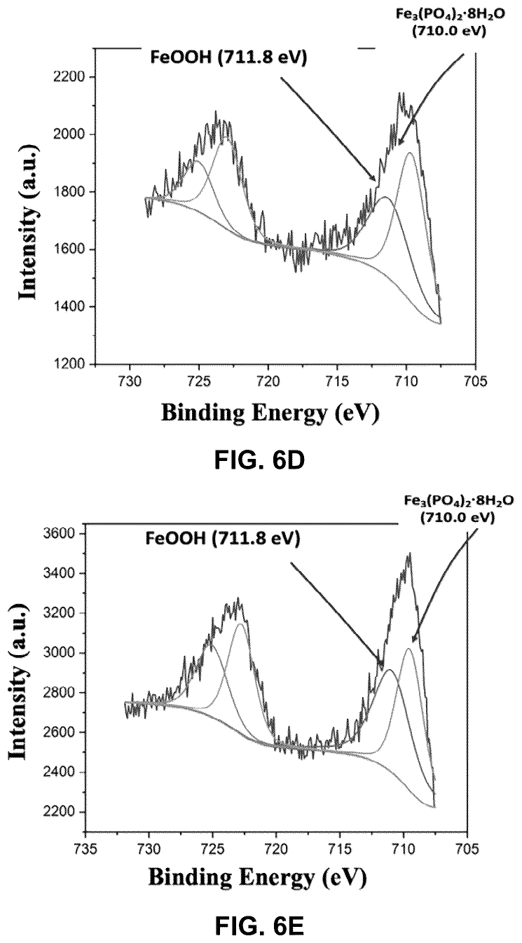

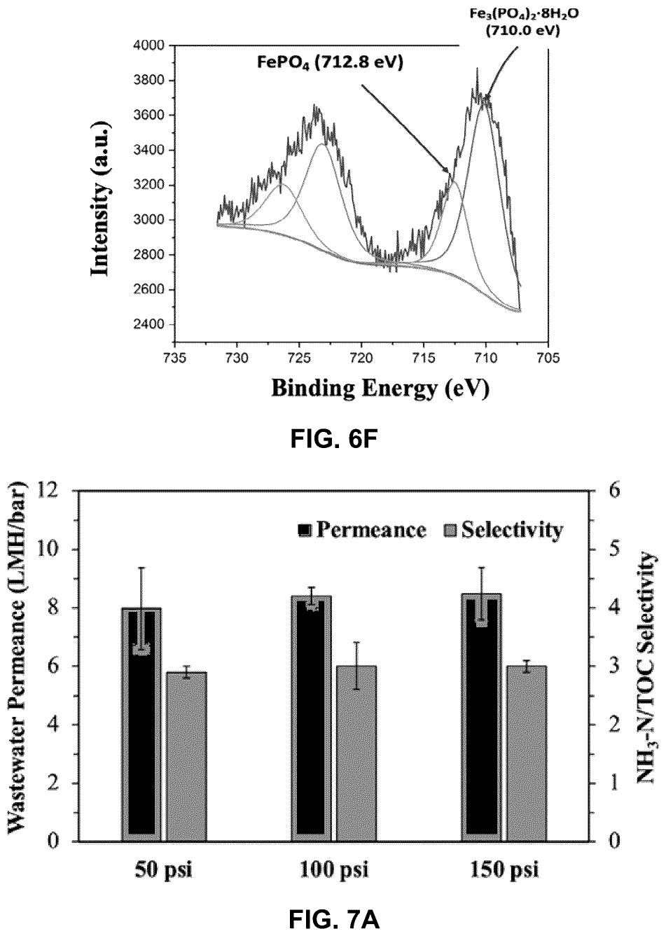

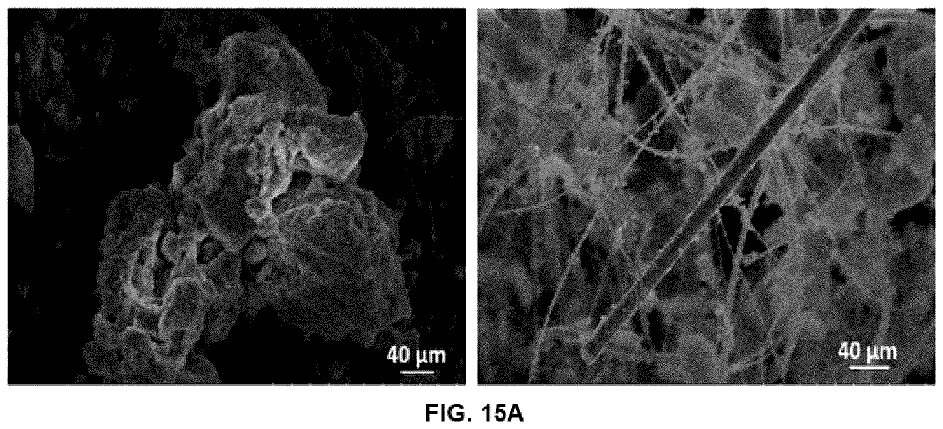

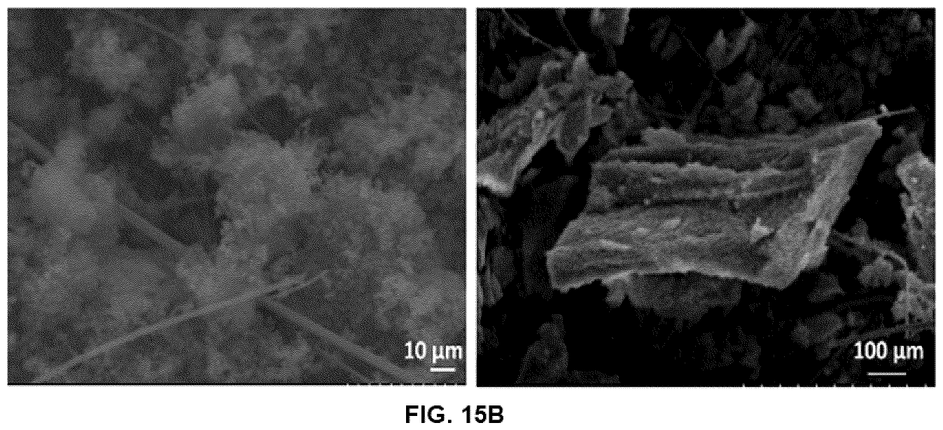

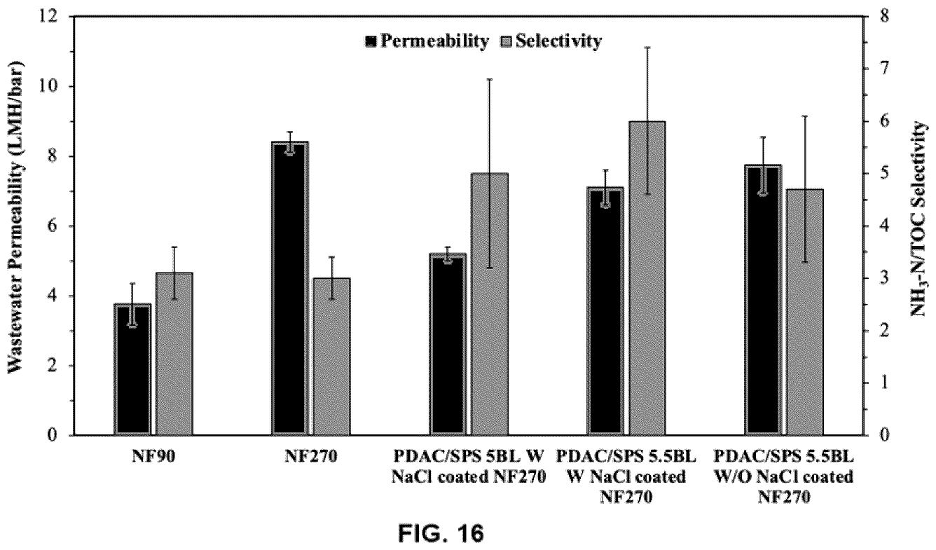

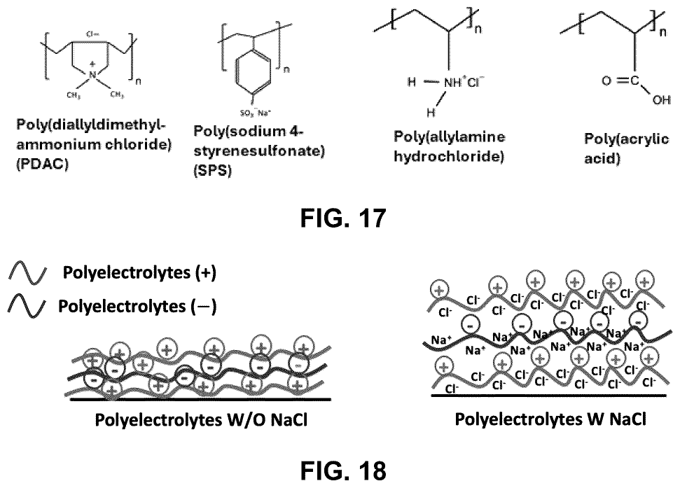

XPS analysis showed Fe, O, and P as the major elements in precipitated solid. Two major peaks were identified in the Fe2p spectrum at 710.0 and 711.8 eV (for Fe/P=0.5 and 1.0), which corresponds to the binding energies of vivianite and goethite respectively (FIGS. 6A-6B). Vivianite was observed as the major chemical precipitate at Fe/P molar ratio of 2.1 with Fe2p spectrum showing the major peak at 710.0 eV (FIG. 6C). These results suggest precipitation of vivianite as the major precipitate from the high ferrous dosage (Fe/P=2.1), while increasing presence of goethite was found with decreasing ferrous dose. Such changes in mineralogy indicate the important role of ferrous dose in regulating purity of vivianite in the precipitated materials. SEM images showed presence of rod-shaped microconcretions, elongated prismatic, and flower-like crystals in the precipitated solid (FIGS. 15A-15B). Similar microconcretions and crystal structures have been previously reported for vivianite in the literature. From EDS analysis, Fe/P molar ratio of the precipitated solid was 1.5, consistent with the stoichiometric ratio of Fe(II) to P in vivianite.

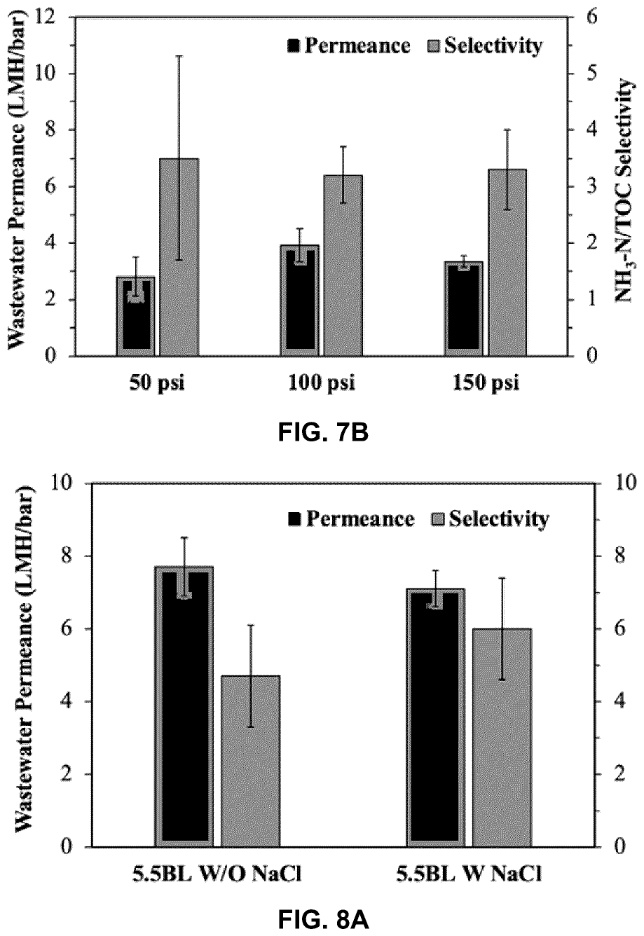

Design of membrane-based processes with high NH₃—N/TOC selectivity: Performance of commercial nanofiltration membranes. Two commercial NF membranes, NF90 and NF270, were tested under a dead-end filtration system with the P-free synthetic anaerobic digestate. NF270 is a “loose” NF membrane with a polypiperazinamide based selective layer (˜14-80 nm in thickness), while NF90 is classified as a “tight” NF membrane with a polyamide-based selective layer (134-214 nm). NF membranes were selected due to their ability to demonstrate high ion selectivities based on both size and charge-based exclusion mechanisms between similar-sized solutes.32 To identify the optimum operating conditions, the membranes were tested under three different pressures at 50, 100, and 150 psi, and their performances were compared in terms of wastewater permeance and NH₃—N/TOC selectivity. The permeance and NH₃—N/TOC selectivity of both membranes were essentially independent of the applied pressure. Under all pressure conditions, NF90 and NF270 membranes had similar selectivities (FIGS. 7A-7B). While the wastewater permeance of NF90 was lower than that of NF270 membrane (FIGS. 7A-7B), both TOC and NH₃—N rejection of NF90 membrane was higher than that of NF270 membrane (Table 5). In fact, TOC rejection of NF90 can reach up to 95% compared with the TOC rejection of NF270 membrane (˜85%), whereas NH₃ rejection of NF90 membrane was ˜1.5× higher than NF270 membrane (Table 5). The higher overall rejections and lower wastewater permeances were not surprising given the lower effective porosity of the polyamide layer in the NF90 membrane versus the polypiperazinamide layer in NF270. The similarity in selectivities between the two membranes could be explained in terms of high rejection of both TOC and NH₃ in case of NF90 and low rejection of both in case of NF270, which resulted in similar NH₃—N/TOC selectivities. To achieve a reasonable flux across the membranes, all experiments were henceforth performed at 100 psi applied pressure.

TABLE 5
Overall performance of commercial membranes at 50 (3.4),
100 (6.9), and 150 (10.3) psi (bar)

| | | Wastewater | Overall | Overall | |
|---|---|---|---|---|---|
| | | permeability, | TOC | NH₃ | NH₃—N/ |
| | Pressure | A | rejection, | rejection, | TOC |
| | (psi) | (LMH/bar) | R_{TOC} (%) | R_{NH3} (%) | Selectivity |
| NF90 | 50 | 2 ± 0.7 | 88 ± 5 | 63 ± 8 | 3.5 ± 1.8 |
| | 100 | 3.8 ± 0.6 | 91 ± 3 | 71 ± 8 | 3.2 ± 0.5 |
| | 150 | 3.6 ± 0.2 | 92 ± 3 | 76 ± 8 | 3.3 ± 0.7 |
| NF270 | 50 | 8 ± 1.4 | 79 ± 1 | 33 ± 4 | 2.9 ± 0.1 |
| | 100 | 8.4 ± 0.3 | 83 ± 1 | 43 ± 6 | 3 ± 0.4 |
| | 150 | 8.5 ± 0.9 | 84 ± 1 | 47 ± 6 | 3 ± 0.1 |

Note:
Experiments were performed under dead-end filtration system at 25° C.

Performance of surface-modified membranes. Modification of the membrane selective layer via LbL was envisioned to offer opportunities to tune the NH₃—N/TOC selectivity of the overall membrane. Since NF270 showed the highest NH₃—N permeance, it was selected as the substrate for polyelectrolyte surface modification. In prior work, such modified membranes showed high performance and lower fouling propensity than commercial membranes with similar intrinsic performance when tested with real wastewater effluents.

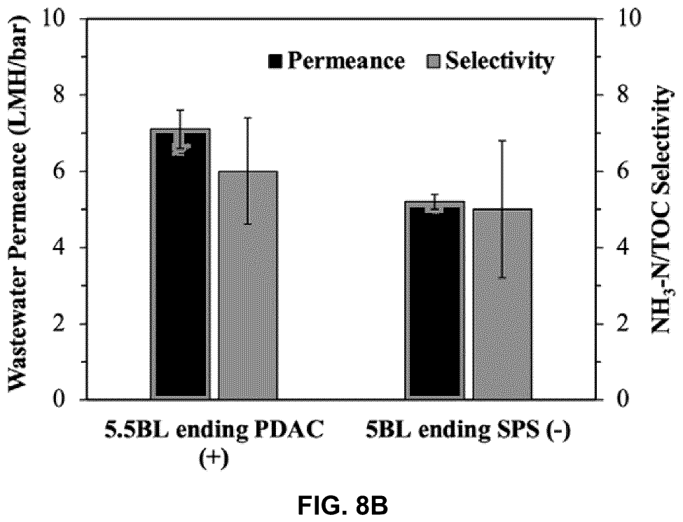

The three sets of polyelectrolyte compositions based on PDAC and SPS described in “Preparation of Polyelectrolyte Membranes” under “Materials and Methods” were used for membrane surface modification, with the goal to understand the effects of the outermost surface layer charge as well as surface charge density on enabling high NH₃—N/TOC selectivities. Selection of this polyelectrolyte combination (i.e., PDAC/SPS) was also based on results from prior studies in which they were shown to significantly enhance the performance of the underlying NF membrane. FIG. 8A shows the effects of surface charge density on the membrane separation performance via modulating the amount of NaCl (0 and 0.5 M) in the polyelectrolyte solutions. It depicts the permeance and selectivity of PDAC/SPS 5.5BL without and with NaCl coated NF270 membranes. NaCl addition is known to increase the bilayer thickness, and this was reflected in the form of slightly lower permeance. Addition of 0.5 M NaCl however led to higher NH₃—N/TOC selectivity, demonstrating the non-trivial effect that surface charge density has on the membrane selectivity. In FIG. 8B, the effect of the outermost surface charge (positive or negative) was investigated by changing the final layer of the multilayer assembly from PDAC to SPS, where both the polyelectrolyte solutions had 0.5 M NaCl in them. FIG. 8B shows a higher permeance and marginally higher selectivity for the 5.5-bilayered membrane with the PDAC outer layer versus the 5-bilayered counter-part. Although both membranes achieved pretty similar TOC rejection, ammonia rejection of PDAC/SPS 5.5BL W NaCl coated NF270 (+) membrane was lower (˜18%) than PDAC/SPS 5BL W NaCl coated NF270 (−) membrane (˜41%) (Table 6).

TABLE 6
Overall performance of all commercial
and modified membranes at 100 psi

| | Pure water | Wastewater | Overall | Overall | |
|---|---|---|---|---|---|
| | permeance | permeance, | TOC | NH₃ | NH₃—N/ |
| | (LMH/ | A | rejection | rejection | TOC |
| Membranes | bar) | (LMH/bar) | (%) | (%) | selectivity |
| NF90 | 7.5 ± 0.7 | 3.8 ± 0.7 | 91 ± 3 | 71 ± 7 | 3.2 ± 0.5 |
| NF270 | 11.1 ± 0.7 | 8.4 ± 0.3 | 83 ± 1 | 43 ± 6 | 3 ± 0.4 |
| PDAC/SPS | 7.9 ± 0.7 | 5.2 ± 0.2 | 88 ± 5 | 41 ± 6 | 5 ± 1.8 |
| 5BL W | | | | | |
| NaCl | | | | | |
| coated | | | | | |
| NF270 | | | | | |
| PDAC/SPS | 8.3 ± 1.2 | 7.1 ± 0.5 | 88 ± 4 | 18 ± 6 | 6 ± 1.5 |
| 5.5BL W | | | | | |
| NaCl | | | | | |
| coated | | | | | |
| NF270 | | | | | |
| PDAC/SPS | 10.3 ± 0.7 | 7.7 ± 0.8 | 89 ± 4 | 45 ± 5 | 4.7 ± 1.4 |
| 5.5BL W/O | | | | | |
| NaCl coated | | | | | |
| NF270 | | | | | |

Note:
Experiments were performed under dead end filtration system at 25° C.

The organic compounds used in the synthetic solution are charge-neutral which explains the TOC rejection being largely independent of the surface charge. At neutral pH, ammonia exists as a combination of ammonium complex (charged) and neutral ammonia and its transport through charged layers is clearly complex and not well understood. Nevertheless, the results in both FIGS. 8A-8B demonstrate that in addition to size-based separation, surface charge is an important factor in determining ammonia permeance and therefore the overall selectivity. Future work will involve detailed mechanistic investigations of these unusually high NH₃—N permeances' of the PDAC/SPS multilayers. Table 6 summarizes the data from the two commercial membranes and three sets of polyelectrolyte multilayer membranes. It is evident that the membrane with outermost positive layer (PDAC) with 0.5 NaCl showed the highest NH₃—N/TOC selectivity and in fact, had 2× selectivity in comparison with the commercial NF270 and NF90 membranes. While the TOC rejection was similar for the bare NF270 and the modified NF270 membranes, the NH₃ rejection of the latter was surprisingly low, that is, the NH₃ permeance was exceptionally high. To analyze this seemingly unusual result, a series resistance calculation was performed, as shown below.

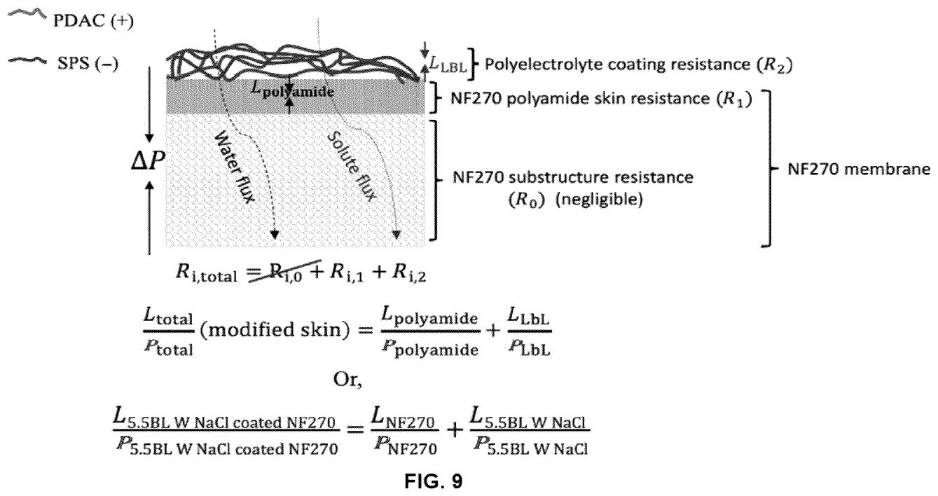

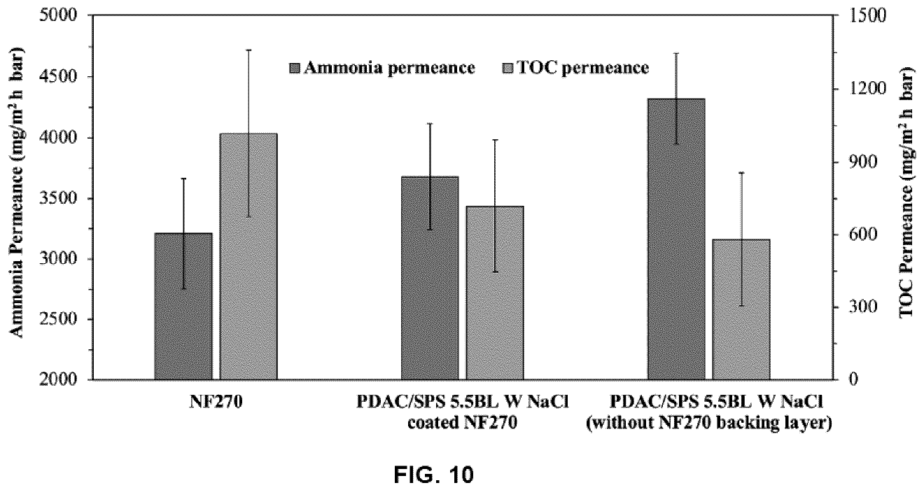

Series-resistance analysis of modified NF270 membrane. The schematic in FIG. 9 shows the approach used for the series-resistance analysis.35 For this specific analysis, only the membrane with the best performance was used, that is, the NF270 membrane modified with 5.5 BL 0.5 M NaCl (PDAC/SPS 5.5BL W NaCl coated NF270). The total resistance (R_{Total}=I/Permeability) of the modified membrane can be assumed to be a sum of the resistances from each individual layer—the porous polysulfone layer (R₀), the selective layer (R₁) and the 5.5 BL coating (R₂). For most practical purposes, R₀ can be assumed to be negligible, which suggests that for the bare NF270 membrane, Rₜₒₜₐₗ=R_{Polyamide}, while for the modified membrane, Rₜₒₜₐₗ=R_{Polyamide}+R_{LbL}. The detailed calculations are shown in Tables 7 and 8. Briefly, the TOC and NH₃ permeances of the bare NF270 membrane and the modified NF270 membrane were estimated using the organic carbon and NH₃ permeate concentrations and the overall wastewater permeances. The thick-ness of the polyamide layer and the polyelectrolyte coating were both estimated to be ˜29 nm based on prior results. As FIG. 10 shows, the NH₃ permeance of the LbL coating is ˜1.4× polyamide layer, while the TOC permeance is slightly lower, thus enabling the overall high selectivity of the coated membrane. It must be noted that this simple model does not consider electrostatic interactions that exist between the polyamide layer and the coated polyelectrolyte as well as between individual polyelectrolytes. However, it helps to understand the relative permeance contributions of the underlying selective layer and the polyelectrolyte coating and informs future membrane material design.

Equations for calculation of ammonia and TOC permeability of PDAC/SPS 5.5BL W NaCl (without NF270 backing layer) using a series resistance model are shown below:

### Ammonia Permeability:

$$\frac{{L}_{5.5 BL W NaCl coated NF 270}}{{P}_{NH 3 , 5.5 BL W NaCl coated NF 270}} = \frac{{L}_{NF 270}}{{P}_{NH 3 , NF 270}} + \frac{{L}_{5.5 BL W NaCl}}{{P}_{NH 3 , 5.5 BL W NaCl}} \qquad ( 9 )$$

### TOC Permeability:

$$\frac{{L}_{5.5 BL W NaCl coated NF 270}}{{P}_{TOC , 5.5 BL W NaCl coated NF 270}} = \frac{{L}_{NF 270}}{{P}_{TOC , NF 270}} + \frac{{L}_{5.5 BL W NaCl}}{{P}_{TOC , 5.5 BL W NaCl}} \qquad ( 10 )$$

### Ammonia Permeability for NF270 Membrane:

$${P}_{NH 3 , NF 270} = {P}_{NF 270} \times {C}_{P , NH 3 , NF 270} \qquad ( 11 )$$

### TOC Permeability for NF270 Membrane:

$${P}_{TOC , NF 270} = {P}_{NF 270} \times {C}_{P , TOC , NF 270} \qquad ( 12 )$$

### Ammonia Permeability for PDAC/SPS 5.5 BL W NaCl Coated NF270 Membrane:

$${P}_{NH 3 , 5.5 BL W NaCl coated NF 270} = {P}_{5.5 BL W NaCl coated NF 270} \times {C}_{P , NH 3 , 5.5 BL W NaCl coated NF 270} \qquad ( 13 )$$

### TOC Permeability PDAC/SPS 5.5 BL W NaCl Coated NF270 Membrane:

$${P}_{TOC , 5.5 BL W NaCl coated NF 270} = {P}_{5.5 BL W NaCl coated NF 270} \times {C}_{P , TOC , 5.5 BL W NaCl coated NF 270} \qquad ( 14 )$$

TABLE 7
Notations and units to the parameters used for analyzing NH₃ and TOC
permeability through series resistance.

| Parameter | Notation | Unit |
|---|---|---|
| Thickness of NF270 membrane | L_{NF270} | nm |
| Thickness of PDAC/SPS 5.5BL | L_{5.5BL W NaCl} | nm |
| W NaCl (without NF270 | | |
| backing layer) | | |
| Thickness of PDAC/SPS 5.5BL | L_{5.5BL W NaCl coated NF270} | nm |
| W NaCl coated NF270 membrane | | |
| Ammonia permeability | P_{NH3,5.5BL W NaCl coated NF270} | mg/m²hr |
| of PDAC/SPS | | bar |
| 5.5BL W NaCl coated NF270 | | |
| membrane | | |
| TOC permeability of PDAC/ | P_{TOC,5.5BL W NaCl coated NF270} | mg/m²hr |
| SPS 5.5BL W NaCl | | bar |
| coated NF270 membrane | | |
| Ammonia permeability of NF270 | P_{NH3,NF270} | mg/m²hr |
| membrane | | bar |
| Ammonia permeability | P_{NH3,5.5BL W NaCl} | mg/m²hr |
| of PDAC/SPS | | bar |
| 5.5BL W NaCl (without | | |
| NF270 backing layer) | | |
| TOC permeability of | P_{TOC,5.5BL W NaCl} | mg/m²hr |
| PDAC/SPS 5.5BL | | bar |
| W NaCl (without NF270 | | |
| backing layer) | | |
| Overall wastewater permeability | P_{NF270} | LMH/bar |
| of NF270 membrane | | |
| Overall wastewater permeability | P_{5.5BL W NaCl coated NF270} | LMH/bar |
| of PDAC/SPS 5.5 BL | | |
| W NaCl coated NF270 | | |
| Ammonia permeate | C_{P,NH3,5.5BL W NaCl coated NF270} | mg/L |
| concentration of PDAC/ | | |
| SPS 5.5BL W NaCl coated | | |
| NF270 membrane | | |
| TOC permeate concentration of | C_{P,TOC,5.5BL W NaCl coated NF270} | mg/L |
| PDAC/SPS 5.5 BL W NaCl | | |
| coated NF270 membrane | | |
| Ammonia permeate concentration | C_{P,NH3,NF270} | mg/L |
| of NF270 membrane | | |
| TOC permeate concentration | C_{P,TOC,NF270} | mg/L |
| of NF270 membrane | | |

TABLE 8
Ammonia and TOC permeability of bare NF270 membrane,
PDAC/SPS 5.5BL W NaCl coated NF270 membrane and
PDAC/SPS 5.5BL W NaCl (without NF270 backing layer)

| | Ammonia | TOC |
|---|---|---|
| | permeability | permeability |
| Membrane | (mg/m²hr bar) | (mg/m²hr bar) |
| NF270 | 3208 ± 457 | 1017 ± 344 |
| PDAC/SPS 5.5BL W NaCl coated NF270 | 3681 ± 436 | 718 ± 272 |
| PDAC/SPS 5.5BL W NaCl (without NF270) | 4323 ± 376 | 581 ± 275 |

While this explains the high performance of the modified membrane, it is clear that such polyelectrolyte-based coatings are very suited for such selective separations. In fact, if such coatings are applied on membranes with low-resistance selective layers, even higher NH₃ recovery could be achieved compared with the modified NF270 case described here.

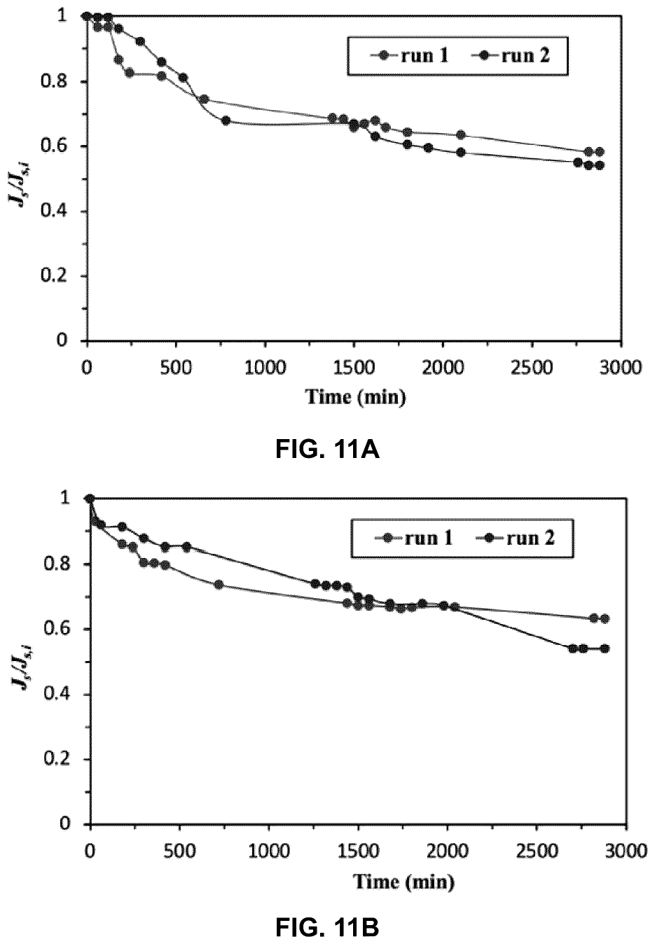

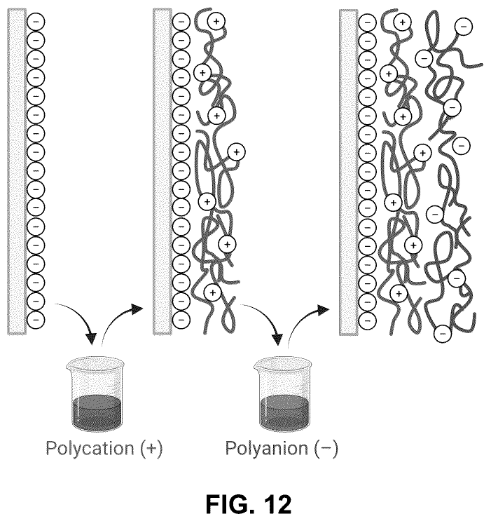

Long-term filtration experiments for fouling and selectivity analysis. PDAC/SPS 5.5BL W NaCl coated NF270 membranes were tested under across flow filtration system for analyzing the long-term performance in terms of fouling and selectivity. Membranes were tested for ˜48 h with synthetic and real digestate. At the end of the 48 h experiment, permeate and retentate samples were collected for calculating rejections (%), and selectivities. For both synthetic and real digestate, two sets of experiments were performed (run 1 and run 2), where nutrients' feed concentrations were the same for each individual digestate. FIGS. 11A-11B show the normalized flux ratios (digestate flux after a certain period, Jₛ/initial digestate flux, J_{s,i}) for synthetic and real digestate. For the synthetic digestate, normalized flux ratios of run 1 and 2 became almost constant after 30 h, and at the end of 48 h, around 60% of initial flux was retained (FIG. 11A). Similar membrane fouling behavior was observed for real digestate (FIG. 11B). TOC rejection for the synthetic digestate can reach ˜88%, whereas NH₃ rejection was around ˜22% (Table 9). The real digestate showed similar selectivities; however, both the TOC rejection as well as NH₃ rejection was higher compared with the synthetic case. With respect to synthetic digestate, real digestate contains more complex organic carbon and ammonia components as well as varied metallic compounds and impurities, which likely contribute to raising both the rejections. Selectivity of synthetic digestate was as high as ˜6.2, whereas real digestate selectivity can reach up to ˜18.8 (Table 9). Further study on the real digestate as well as constituent analysis of the digestate is needed in the future to validate this hypothesis. The large variation in selectivity in case of the real digestate reflects the lack of homogeneity in real digestate solutions. A multistage membrane process could clearly enable achieving higher overall selectivities.

TABLE 9
Overall long-term performance of PDAC/SPS
5.5 BL w NaCl coated NF270 membrane

| | | | Wastewater | | | |
|---|---|---|---|---|---|---|
| | | Pure water | permeance, | Overall TOC | Overall NH₃ | |
| | | permeance | A | rejection, | rejection, | NH₃-N/TOC |
| | | (LMH/bar) | (LMH/bar) | R_{TOC} (%) | R_{NH3} (%) | selectivity |
| Synthetic | Run 1 | 9.5 | 4.8 | 88 | 22 | 6.2 |
| digestate | Run 2 | 9.9 | 4.6 | 82 | 22 | 4.4 |
| Real | Run 1 | 10.3 | 5.3 | 93 | 49 | 6 |
| digestate | Run 2 | 9.5 | 4.2 | 97 | 50 | 18.8 |

Note:
Wastewater permeance, TOC, and NH₃ rejection values were taken after the end of the 48 h experiment. Experiments were performed under cross flow filtration system at 25° C. and 100 psi.

### CONCLUSION

This study depicted the potential of 100% P recovery as pure vivianite from digestate with the ferrous dose at Fe/P molar ratio of 2.1. With P-free digestate, surface modified PDAC/SPS 5.5BL W NaCl coated NF270 membrane can achieve ˜2× higher NH₃—N/TOC selectivity compared with commercial NF (NF90 and NF270) membranes. The series resistance model revealed that such polyelectrolyte multilayer coatings could provide a high NH₃—N and low TOC permeance in comparison to commercial NF270 membranes. The results further demonstrated the potential of this combined strategy to recover both P and NH₃ under neutral pH conditions. In this respect, this integrated chemical precipitation and membrane separation technique could provide a sustainable route for phosphorus and ammonia recovery by eliminating the chemical cost for pH adjustment and reducing the energy requirements and CO₂ emissions with respect to traditional approaches.

### Example 2: Use of Surface-Modified PEM Membranes

### Materials and Methods

Poly(allylamine hydrochloride) (PAH, molecular weight ˜17500 g/mole), poly(diallyl dimethylammonium chloride (PDAC, 20 wt % in H₂O), Polyethylenimine (PEI, branched, molecular weight ˜25000 g/mole) and poly(sodium 4-styrenesulfonate) (SPS, molecular weight ˜70,000 g/mol) were purchased from Sigma-Aldrich (St. Louis, MO, USA). Poly(acrylic acid, sodium salt) (PAA, molecular weight ˜225,000 g/mol) (20 wt % in water) was purchased from Polysciences Inc. (Warrington, PA, USA). Sodium chloride (NaCl) (99% w/w), hydrochloric acid (HCl) (37% v/v), sodium hydroxide (NaOH) (≥97% w/w), Glutaraldehyde (GA) (50 wt % in water), N-(3-Dimethylaminopropyl)-N′-ethylcarbodiimide (EDC) (297% w/v), and poly(ethylene glycol) (PEG) molecular weight 300 and 400 g/mol were purchased from Sigma-Aldrich. 2-(N-morpholino) ethanesulfonic acid (MES) (≥99% w/v) buffer was purchased from VWR. Commercial NF270 nanofiltration membrane was purchased from DuPont Water Solutions (Edina, MN, USA) and used as the support for the fabrication of polyelectrolyte multilayer membranes. Polyethersulfone, PES (MWCO 5000 Da) and polysulfone, PSF (MWCO 10000 Da) ultrafiltration membranes were purchased from Alfa Laval Inc. (Richmond, VA, USA). Glycerol (99% W/V) and D(+)-Glucose was purchased from Thermo Scientific (Waltham, MA, USA). Sodium phosphate monobasic (NaH₂PO₄·2H₂O), ammonium chloride (NH₄Cl), sodium acetate anhydrous (C₂H₃NaO₂), ethanol (C₂H₆O), and ferrous sulfate heptahydrate were purchased from HACH (Loveland, CO, USA). D-lactose monohydrate (C₁₂H₂₂O₁₁·H₂O) was purchased from Research Product International (RPI) (Mount Prospect, IL, USA). Potassium chloride (KCl) was purchased from Fisher Scientific (Hampton, NH, USA). Spherical silica gel (10 μm diameter) was purchased from VWR International (Radnor, Pennsylvania, USA). All purchased chemicals were used as received.

### Preparation of Synthetic Wastewater

Sodium phosphate monobasic (NaH₂PO₄·2H₂O), ammonium chloride (NH₄Cl) and Potassium chloride (KCl) were used sources of phosphorus, ammonium and potassium, respectively. For organic pollutant source, three different molecular weight organic compounds—ethanol (C₂H₆O, MW˜46 g/mole), sodium acetate anhydrous (C₂H₃NaO₂, MW˜82 g/mole), and D-lactose monohydrate (C₁₂H₂₂O₁₁·H₂O, MW˜360 g/mole) were utilized. The synthetic wastewater was prepared by conducting literature reviews of AD supernatant from various municipal wastewater plants and a local municipal wastewater treatment facility located in Morgantown, WV, USA and following feed concentrations of nutrients and organic pollutants were maintained throughout the study: Phosphorus: 100 mg/L; organic pollutant: 650-750 mg/L; NH₄⁺: 550-650 mg/L and K⁺: 60-80 mg/L. Feed solution pH was unchanged since it remained within the neutral range (pH 6˜7).

To assess the rejection performance of individual organic pollutants, four distinct organic components with molecular weights ranging from 92 to 400 g/mole were employed. These components include glycerol (92 g/mole, 1000 μL/L), glucose (180 g/mole, 1000 mg/L), PEG (300 g/mole, 1000 μL/L), and PEG (400 g/mole, 1000 μL/L). Individual samples were prepared by using each organic component and then subjected to testing using both commercial NF270 and modified PEM membranes.

### Fabrication of Polyelectrolyte Multilayer Membrane

Polyelectrolyte multilayer membrane was fabricated using layer by layer (LbL) dip-coating of positive and negatively charged polyelectrolyte on top of NF270 membrane selective layer (feed side) following a similar protocol as previous studies. Prior to the LbL experiment, NF270 membranes were immersed in DI water overnight. Before starting the experiment, permeate side of the membrane was covered with four alternate sheets of parafilm and aluminum foils to prevent coating from occurring on that side. All polyelectrolyte solutions were used at a concentration of 10 mmol/L (mM) with respect to their repeat unit (molecular weights of monomer). Solutions were prepared in 18.2 MΩ DI water with and without 0.5 M NaCl. NF270 membrane support was at first dipped in the positively (+) charged polyelectrolyte solution for 10 min followed by three consecutive DI water washing steps through dipping for 2+2+1 min or 1+1+1 min. Then the membrane was dipped in negatively (−) charged polyelectrolyte for 10 min, followed by the same three DI water washing steps through dipping for the same 2+2+1 min or 1+1+1 min. Deposition of these two alternatively charged polyelectrolytes was repeated 11 times, resulting in 5.5 bilayers of PEM membranes ending with positively charged polyelectrolytes. Some membranes were dipped for 24 hours and for these membranes, only 1 layer of polyelectrolyte films were deposited followed by three DI water washing steps for 1+1+1 minutes. Upon completion of LbL deposition process, the membrane samples were soaked in DI water overnight prior to the filtration experiments.

The polyelectrolyte combinations used in this work can be broadly classified into (a) polyelectrolytes with ionic (or electrostatic) bonding and (b) polyelectrolytes with hydrogen bonding and covalent crosslinking.

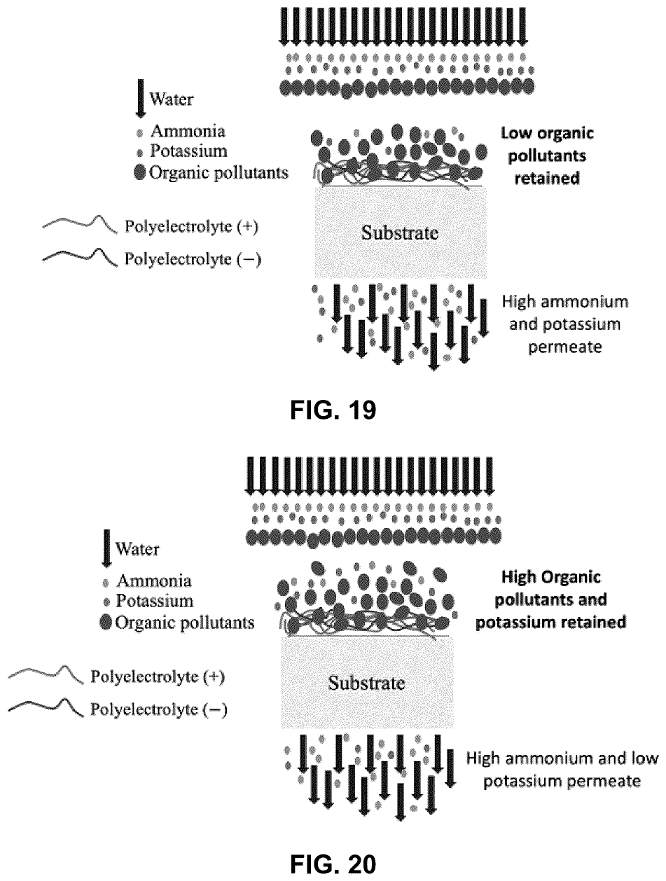

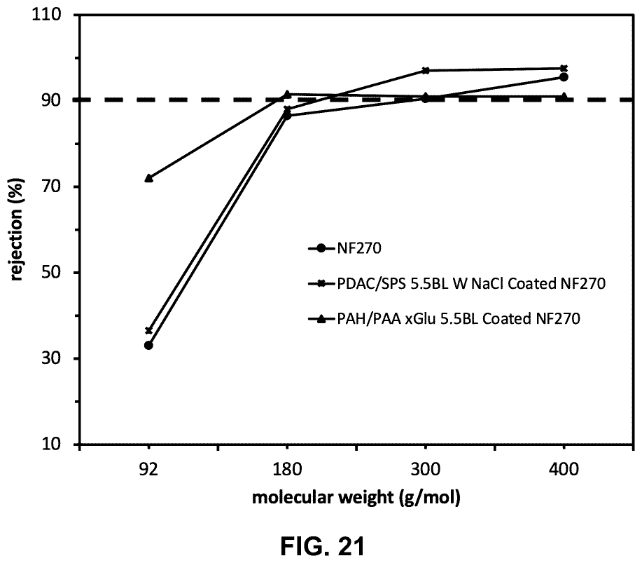

Polyelectrolytes with ionic bonding. Poly(diallyl dimethylammonium chloride (PDAC) (+) and Poly(sodium 4-styrenesulfonate (SPS) (−) (FIGS. 19-20) are strong polyelectrolytes and fully ionized within solution over a wide range of pH. Here, strong electrostatic interaction is present between the polyelectrolytes when coated on top of a specific substrate. When polyelectrolyte solutions are prepared without any addition of salt and coated upon a substrate, intrinsic charge compensation of both polyelectrolytes within layers can occur, resulting in the formation of surface-modified membrane with little to no surface charge density due to the charge-balance between the counter polyelectrolyte ions (FIG. 21). Addition of salt (NaCl) within polyelectrolyte solution can extrinsically compensate the charge effect by supplying additional Na⁺ and Cl⁻ counter ions and providing a high surface charge density to the modified membranes (FIG. 21).

Polyelectrolytes with hydrogen bonding or covalent crosslinking. poly(allylamine hydrochloride) (PAH) (+) and poly(acrylic acid) (PAA) (−) (FIG. 1) are weak polyelectrolytes and depending on the pH and degree of ionizations, interaction between these polyelectrolytes can be electrostatic or hydrogen-bonded. When polyelectrolytes are full ionized, strong electrostatic interaction is present between the polyelectrolytes, whereas partial ionization resulting in weak hydrogen bonding. Cross-linking with 1-ethyl-3-(3-dimethylaminopropyl) carbodiimide hydrochloride (EDC) or glutaraldehyde (Glu) enable the formation of more dense multilayer film by forming covalent bonding between polyelectrolytes or with the cross-linked polymer.

The following polyelectrolyte combinations have been used herein:
Set 1—(PDAC/SPS 5BL W NaCl coated NF270): 5 bilayers of PDAC and SPS (both in 0.5 M NaCl) were deposited on NF 270 substrate, therefore ending with a negatively charged (SPS) outermost layer. Note that in some aspects of this disclosure, this membrane was also designated as “NF270[PDAC/SPS w NaCl]₅”.
Set 2—(PDAC/SPS 5.5BL W NaCl coated NF270): 5.5 bilayers of PDAC and SPS (both in 0.5 M NaCl) were deposited on NF 270 substrate, therefore ending with a positively charged (PDAC) outermost layer. Note that in some aspects of this disclosure, this membrane was also designated as “NF270[PDAC/SPS w NaCl]_{5.5}”.
Set 3—(PDAC/SPS 5.5BL without NaCl coated NF270): 5.5 bilayers of PDAC and SPS (both in pure DI without NaCl) were deposited on NF 270 substrate, therefore ending with a positively charged (PDAC) outermost layer. Note that in some aspects of this disclosure, this membrane was also designated as “NF270[PDAC/SPS w/o NaCl]_{5.5}”.
Set 4—(PAH/PAA 5.5BL without NaCl coated NF270): 5.5 bilayers of PAH and PAA (both in pure DI without NaCl) were deposited on NF 270 substrate, therefore ending with a positively charged (PAH) outermost layer. Note that in some aspects of this disclosure, this membrane was also designated as “NF270[PAH/PAA w/o NaCl]_{5.5}”.
Set 5—(PAH/PAA 5.5BL W NaCl coated NF270): 5.5 bilayers of PAH and PAA (both in 0.5 M NaCl) were deposited on NF 270 substrate, therefore ending with a positively charged (PAH) outermost layer. Note that in some aspects of this disclosure, this membrane was also designated as “NF270[PAH/PAA w NaCl]_{5.5}”.
Set 6—(PAH/PAA 6.5/6.5 5.5BL W NaCl coated NF270): 5.5 bilayers of PAH and PAA (both in DI water with pH 6.5) were deposited on NF 270 substrate, therefore ending with a positively charged (PAH) outermost layer. Note that in some aspects of this disclosure, this membrane was also designated as “NF270[PAH(6.5)/PAA(6.5)]_{5.5}”.
Set 7—(PAH/PAA 8.5/3.5 5.5BL coated NF270): 5.5 bilayers of PAH (in DI water with pH 8.5) and PAA (in DI water with pH 3.5) were deposited on NF 270 substrate, therefore ending with a positively charged (PAH) outermost layer. Note that in some aspects of this disclosure, this membrane was also designated as “NF270[PAH(8.5)/PAA(3.5)]_{5.5}”.
Set 8—(PAH/PAA×EDC 5.5BL coated NF270): 5.5 bilayers of PAH (in DI water with pH 8.5) and PAA (in DI water with pH 3.5) were deposited on NF 270 substrate and then cross-linked by dipping inside EDC (50 mM EDC in 50 mg/ml 2-(N-morpholino) ethanesulfonic acid (MES) buffer at pH 5.5) solution for 60 minutes followed by three DI washing (5+5+5 minutes), therefore ending with PAH outermost layer.
Set 9—(PAH/PAA xGlu 5.5BL coated NF270): 5.5 bilayers of PAH (in DI water with pH 8.5) and PAA (in DI water with pH 3.5) were deposited on NF 270 substrate and then cross-linked by dipping inside 1.5 wt % Glutaraldehyde solution for 90 minutes followed by three DI washing (15+15+15 minutes), therefore ending with less-positively charged (PAH) outermost layer. Note that in some aspects of this disclosure, this membrane was also designated as “NF270[PAH(8.5)/PAA(3.5)]_{5.5}×GA”.
Set 10—NF270[PEI(8.5)/PAA(3.5)]_{5.5}×GA2.5: 5.5 bilayers of PEI (1 g/L in DI water with pH 8.5) and PAA (10 mM in DI water with pH 3.5) were deposited on NF 270 substrate and then cross-linked by dipping inside 2.5 wt % Glutaraldehyde solution for 150 minutes followed by three DI washing (5+5+5 minutes).
Set 11—NF270[PEI(8.5)/PAA(3.5)]_{5.5}×GA-3.5: 5.5 bilayers of PEI (1 g/L in DI water with pH 8.5) and PAA (10 mM in DI water with pH 3.5) were deposited on NF 270 substrate and then cross-linked by dipping inside 3.5 wt % Glutaraldehyde solution for 150 minutes followed by three DI washing (5+5+5 minutes).
Set 12—NF270[PEI(8.5)/PAA(3.5)]_{5.5}×EDC: 5.5 bilayers of PEI (1 g/L in DI water with pH 8.5) and PAA (10 mM in DI water with pH 3.5) were deposited on NF 270 substrate and then cross-linked by dipping inside EDC (50 mM EDC in 50 mg/ml 2-(N-morpholino) ethanesulfonic acid (MES) buffer at pH 5.5) solution for 60 minutes followed by three DI washing (5+5+5 minutes), therefore ending with PEI outermost layer.
Set 13—NF270[PAH(8.5)/PEI(8.5)]_{0.5}×GA-0.5: Co-deposition in PAH-PEI solution (both 1 g/L in DI water with pH 8.5) on NF 270 substrate for 24 hour and then cross-linked by dipping inside 0.5 wt % Glutaraldehyde solution for 90 minutes followed by three DI washing (5+5+5 minutes).
Set 14—NF270[PAH(8.5)/PEI(8.5)]_{0.5}×GA-1.5: Co-deposition in PAH-PEI solution (both 1 g/L in DI water with pH 8.5) on NF 270 substrate for 24 hour and then cross-linked by dipping inside 1.5 wt % Glutaraldehyde solution for 90 minutes followed by three DI washing (5+5+5 minutes).
Set 15—NF270[PAH(8.5)/PEI(8.5)]_{0.5}×GA-2.5: Co-deposition in PAH-PEI solution (both 1 g/L in DI water with pH 8.5) on NF 270 substrate for 24 hour and then cross-linked by dipping inside 2.5 wt % Glutaraldehyde solution for 150 minutes followed by three DI washing (5+5+5 minutes).
Set 16—NF270[PAH(8.5)/PEI(8.5)]_{0.5}: Co-deposition in PAH-PEI solution (both 1 g/L in DI water with pH 8.5) on NF 270 substrate for 24 hours followed by three DI washing (1+1+1 minutes).
NF270[PEI(8.5)/PAA(3.5)]_{5.5}: 5.5 bilayers of PEI (1 g/L in DI water with pH 8.5) and PAA (10 mM in DI water with pH 3.5) were deposited on NF 270 substrate, therefore ending with a positively charged (PEI) outermost layer.

### Results and Discussion

In this study, membranes were tested with three different synthetic digestate after phosphorus recovery. Initially, filtration experiments were performed using the synthetic digestate containing ammonium, and organic carbon without the presence of potassium to observe ammonium recovery performance and organic carbon rejection capability.

TABLE 10
Performance of commercial and modified membranes tested with
wastewater containing NH₄⁺ and TOC

| | | | Organic | Ammonium | Selectivity |
|---|---|---|---|---|---|
| | Pure water | Wastewater | pollutant | (NH₄⁺) | (NH₄⁺/ |
| | permeance | permeance | rejection | rejection | Organic |
| Membranes | (LMH/bar) | (LMH/bar) | (%) | (%) | pollutant) |
| PSF10K | 26.2 | 19 | 5 | 0 | 1.06 |
| PES5K | 23.9 | 15.5 | 10 | 2 | 1.09 |
| NF90 | 7.5 ± 0.7 | 3.8 ± 0.7 | 91 ± 3 | 71 ± 7 | 3.2 ± 0.5 |
| NF270 | 15.5 ± 1.2 | 11.1 ± 0.7 | 83 ± 2 | 47 ± 4 | 3.0 ± 0.7 |
| NF270 [PDAC/SPS w | 7.9 ± 0.7 | 5.2 ± 0.2 | 88 ± 5 | 41 ± 6 | 5 ± 1.8 |
| NaCl]₅ | | | | | |
| NF270 [PDAC/SPS w | 8.3 ± 0 | 7.1 ± 0 | 86 ± 1 | 17 ± 1 | 5.2 ± 0.4 |
| NaCl]_{5.5} | | | | | |
| NF270 [PDAC/SPS w/o | 10.3 ± 0.7 | 7.7 ± 0.8 | 89 ± 4 | 45 ± 5 | 4.7 ± 1.4 |
| NaCl]_{5.5} | | | | | |
| NF270 [PAH/PAA w/o | 13.9 ± 0.7 | 9.9 ± 0.7 | 84 ± 1 | 32 ± 1 | 3.8 ± 0.1 |
| NaCl]_{5.5} | | | | | |
| NF270 [PAH/PAA | 13.5 ± 0.7 | 9.5 ± 0 | 85 ± 3 | 26 ± 1 | 4.9 ± 1.3 |
| w NaCl]_{5.5} | | | | | |
| NF270 | 12.7 ± 0.7 | 9.9 ± 0.7 | 83 ± 3 | 35 ± 4 | 3.6 ± 0.5 |
| [PAH(6.5)/PAA(6.5)]_{5.5} | | | | | |
| NF270 | 2.4 ± 0.8 | 1.9 ± 0.7 | 86 ± 2 | 23 ± 3 | 4.9 ± 0.6 |
| [PAH(8.5)/PAA(3.5)]_{5.5} | | | | | |
| NF270 | 0.8 ± 0.1 | 0.5 ± 0.1 | 93 ± 2 | 45 ± 6 | 7.6 ± 1.9 |
| [PAH(8.5)/PAA(3.5)]_{5.5} | | | | | |
| xGA | | | | | |

From these experiments, best-performed membranes were picked, and these membranes were used to observe nutrient recovery (ammonium and potassium) performance from the digestate containing ammonium (NH₃—N), potassium (K⁺) and organic carbon and results were listed in Table 11. Some membranes were also tested with binary mixtures of ammonium (NH₃—N) and potassium (K⁺) to observe NH₃—N/K⁺ selectivities without any presence of organics and results were shown in Table 12 and Table 13.

TABLE 11
Overall performance of all commercial NF270 and modified PEM membranes when tested
with concentrated wastewater containing ammonium, potassium and organic pollutants

| | Wastewater | Organic | Ammonium | Potassium | | | |
|---|---|---|---|---|---|---|---|
| | permeability | (TOC) | (NH₃-N) | (K⁺) | Selectivity | | |
| | (Jₛ (Lm⁻² hr⁻¹ | rejection | rejection | rejection | (NH₃-N / | Selectivity | Selectivity |
| Membrane | bar⁻¹) | (%) | (%) | (%) | TOC) | (K⁺/TOC) | (NH₃-N/K⁺) |
| NF270 | 9.9 ± 0.7 | 82 ± 2 | 36 ± 3 | 37 ± 2 | 3.3 ± 0.3 | 3.4 ± 0.2 | 0.96 ± 0.01 |
| PDAC/SPS | 6.0 ± 1.2 | 82 ± 1 | 19 ± 4 | 27 ± 2 | 4.0 ± 0.1 | 3.7 ± 0.2 | 1.07 ± 0.07 |
| 5.5BL W | | | | | | | |
| NaCl | | | | | | | |
| Coated | | | | | | | |
| NF270 | | | | | | | |
| PAH/PAA | 0.7 ± 0.2 | 91 ± 2 | 39 ± 6 | 53 ± 3 | 6.1 ± 0.6 | 4.8 ± 0.3 | 1.26 ± 0.05 |
| xGlu 5.5BL | | | | | | | |
| Coated | | | | | | | |
| NF270 | | | | | | | |
| PAH/PAA | 8.7 ± 0.7 | 84 ± 1 | 25 ± 2 | 29 ± 1 | 4.2 ± 0.1 | 4.1 ± 0.2 | 1.03 ± 0.04 |
| 5.5BL W | | | | | | | |
| NaCl | | | | | | | |
| Coated | | | | | | | |
| NF270 | | | | | | | |
| PAH/PAA | 1.6 ± 0.7 | 85 ± 2 | 30 ± 1 | 38 ± 2 | 4.2 ± 0.6 | 3.7 ± 0.5 | 1.12 ± 0.03 |
| 8.5/3.5 | | | | | | | |
| 5.5BL | | | | | | | |
| Coated | | | | | | | |
| NF270 | | | | | | | |

TABLE 12
Performance of commercial NF270, type-1 (PDAC/SPS 5.5BL W NaCl
Coated NF270) and type-2 (PAH/PAA xGlu 5.5BL Coated NF270)
when tested with a binary mixture of NH₄⁺ and K⁺

| | Ammonium | Potassium | |
|---|---|---|---|
| | (NH₃—N) | (K⁺) | Selectivity |
| Membranes | rejection (%) | rejection (%) | (NH₃—N/K⁺) |
| NF270 | 32 ± 0 | 31 ± 1 | 0.98 ± 0.03 |
| PDAC/SPS 5.5BL W | 14 ± 2 | 19 ± 4 | 1.04 ± 0.09 |
| NaCl Coated NF270 | | | |
| PAH/PAA NF270 xGlu | 40 ± 3 | 66 ± 4 | 1.78 ± 0.20 |
| 5.5BL Coated NF270 | | | |

TABLE 13
Additional evidence of NH4+/K+ separation performance of crosslinked
polyelectrolyte membranes when tested with equimolar (10 mM)
NH4+/K+ mixtures

| | Pure water | Solution | NH₃—N | K⁺ | |
|---|---|---|---|---|---|
| | permeance | permeance | rejection | rejection | NH₃—N/K⁺ |
| Membranes | (LMH/bar) | (LMH/bar) | (%) | (%) | selectivity |
| NF270 | 22 ± 1 | 28 ± 3 | 22 ± 1 | 28 ± 3 | 1.12 ± 0.06 |
| NF270 [PAH-PEI]0.5 | 10.8 ± 0 | 8.7 ± 0.7 | 27 ± 7 | 51 ± 7 | 1.44 ± 0.09 |
| NF270 [PAH-PEI]0.5 | 6.0 | 4.8 | 56 | 83 | 2.5 |
| xGA2.5 | | | | | |
| NF270 [PAH-PEI]0.5 | 6.8 ± 1.1 | 5.7 ± 0.6 | 40 ± 4 | 78 ± 4 | 2.55 ± 0.30 |
| xGA1.5 | | | | | |
| NF270 [PAH-PEI]0.5 | 7.5 ± 0.7 | 6.0 ± 0 | 36 ± 4 | 72 ± 4 | 2.23 ± 0.29 |
| xGA0.5 | | | | | |
| NF270 [PEI/PAA]5.5* | 8.9 ± 0.9 | 8.3 ± 0 | 11 ± 3 | 36 ± 11 | 1.41 ± 0 |
| NF270 [PEI/PAA]5.5 | 6.0 ± 1.0 | 5.1 ± 1.1 | 24 ± 4 | 62 ± 8 | 2.00 ± 0.36 |
| xGA 2.5 | | | | | |
| NF270 [PEV/PAA]5.5 | 5.7 ± 0.6 | 5.1 ± 0.6 | 18 ± 3 | 57 ± 8 | 1.84 ± 0.27 |
| xGA 3.5 | | | | | |
| NF270 [PEI/PAA]5.5 | 6.7 ± 1.4 | 6.4 ± 0.7 | 25 ± 6 | 56 ± 4 | 1.67 ± 0.14 |
| xEDC | | | | | |
| NF270 [PAH/PAA]5.5 | 0.7 ± 0.2 | 0.5 ± 0.1 | 26 ± 5 | 58 ± 2 | 1.64 ± 0.09 |
| xGA 1.5 | | | | | |
| NF270 [PAH/PAA]5.5 | 1.6 ± 0.2 | 1.7 ± 0.1 | 24 ± 2 | 47 ± 4 | 1.42 ± 0.11 |
| xEDC | | | | | |

Performance of commercial nanofiltration membranes. Two commercial NF membranes, NF90 and NF270 (“loose” NF membrane), were selected due to their ability to demonstrate high ion selectivities based on both size and charge-based exclusion mechanisms between similar-sized solutes. As seen from the table, the performance of the polyelectrolyte-coated membranes have the ability to surpass that of commercial membranes when optimized.

NF90 membrane. NF90 had a tight polyamide layer with lower effective porosity. When tested with AD containing ammonium and organic carbon, this type of coated membrane can achieve ˜91% TOO and ˜71% ammonium rejection with a NH₃—N/TOC selectivity of ˜3.2 (Table 10).

NF270 membrane. NF270 had a polypiperazinamide layer with higher effective porosity. When tested with AD containing ammonium and organic carbon, this type of coated membrane can achieve ˜83% TOO and ˜43% ammonium rejection with a NH₃—N/TOC selectivity of ˜3.0 (Table 10).

Organic pollutant rejections of commercial and coated membranes (type-1 and type-2). Rejections of organic pollutants in presence of either ammonium (NH₃—N) or mixtures of ammonium (NH₄⁺) and potassium (K⁺) were shown in Tables 11 and 12. Both commercial and type-1 membranes had similar organic pollutants rejection whereas cross-linked type 2 membrane had high organic retention (>90%). FIG. 21 shows the examples of molecular weight cutoffs for commercial NF270 and both type-1 and type-2 membranes where commercial NF270 membrane had higher molecular weight cutoff (˜290 g/mole) compared to both type-1 (˜220 g/mole) and type-2 (˜170 g/mole) membranes. The only difference is the rejection of smaller molecular weight component (in this case, glycerol 92 g/mole), where cross-linked type-2 membrane shows significantly higher organic rejection (>70%) compared to both type-1 and commercial NF270 membranes (30-40%) (FIG. 21). This is the main reason for higher organic pollutant rejections of type-2 membrane compared to both commercial and type-1 membranes.

NH₃—N/K+ selectivity of commercial and coated (type-1 and type-2) membranes. In this work, two types of surface-modified membranes were discovered (FIGS. 19-20). Type-1 membranes had higher ammonium and potassium permeance whereas similar organic pollutant retention as that of commercial NF membranes and therefore, providing higher NH₃—N/TOC and K⁺/TOC selectivity. These membranes had low NH₃—N/K⁺ selectivity. Type-2 membrane is the cross-linked polyelectrolyte multilayer membrane. It had significantly higher organic pollutant and potassium retention whereas ammonium permeance was similar as that of commercial NF membranes and therefore, providing higher NH₃—N/TOC and K⁺/TOC selectivity. These membranes also had high NH₃—N/K⁺ selectivity. The NH₃—N/K⁺ selectivity was also validated with a simple synthetic binary mixture of NH₃—N and K⁺, proving that the selectivity attained is largely independent of TOC presence in the feed stream. The results from this test are presented in Table 12.

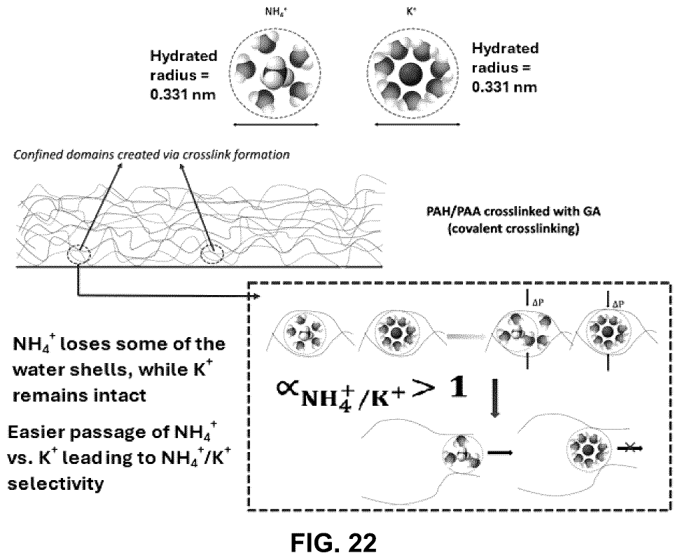

In the case of cross-linked membrane (PAH/PAA xGlu 5.5BL coated NF270 membrane) (type 2), NH₃—N rejection is significantly lower (˜1.5×) than K⁺ and it is possible to achieve a high NH₃—N/K selectivity (˜1.26 for NH₃—N/K⁺/organic mixture and ˜1.78 for binary NH₃—N/K mixtures). Although ammonium and potassium have the exact same hydrated radii (0.33 nm), the differences between the high N/K selectivity is attributed to the differences in ion solvation properties (local water structure in the nearest solvation shell of ammonium is surrounded by lower water molecules than potassium) between ammonium and potassium ions. It is believed that the crosslinked membranes create confinement domains for both ions (FIG. 22). ammonium, due to its weaker hydration energy tends to lose its hydration shells under pressure within these crosslinked domains and therefore permeates faster than K⁺. This is practically important since this could allow varied ammonium and K⁺ ratios in the permeate and when mixed with P recovered via vivianite precipitation, a final product of varying N:P:K ratios can be generated according to the demands of a given situation. In addition, this clearly sets these Type 2 coated membranes apart from commercial membranes, where <1 selectivity is attained. This is also a fundamentally interesting phenomenon and has not been reported elsewhere.

### Example 3: Unveiling Nutrient-Organic Co-Transport Mechanism Via Polyelectrolyte Surface Modification to Engineer Nutrient-Selective NF Membrane

### Experimental Protocol for Analyzing Membrane Performance

Prior to undergoing treatment with surface-modified PEM membranes, synthetic wastewater was subjected to a predetermined ferrous (II) solution with a molar ratio of 2.1:1 Fe/P, facilitating the formation of vivianite through chemical precipitation and effectively removing all phosphate content. The detailed experimental procedure can be found in an earlier study. This solution was then filtered using a polyethersulfone (0.45 m) microfiltration membrane and solid precipitate as a form of vivianite was separated. The remaining wastewater solution comprises a ternary mixture of ammonium (NH₄), potassium (K⁺), and organic pollutants (TOC), and was used as feed solution for all the membranes.

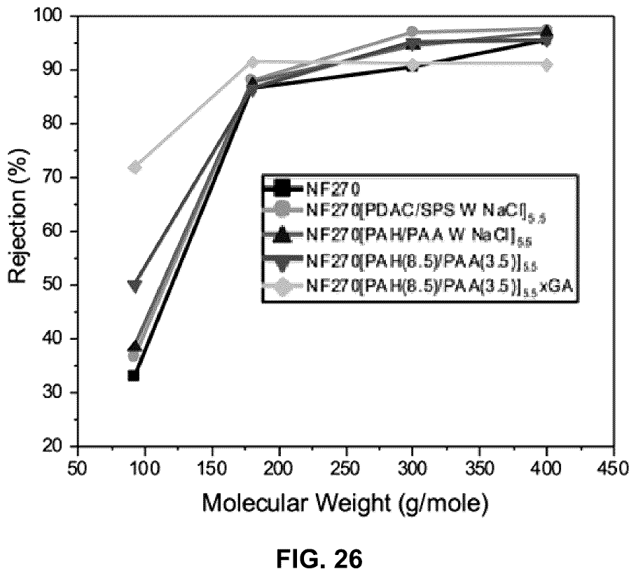

All membranes were tested using a HP 4750 stirred dead-end filtration cell system (Sterlitech, Kent, Washington). The volume of the filtration system is approximately 300 mL, and the effective membrane filtration area is around 14.6 cm². Ultra-pure N₂ was used to provide the required transmembrane pressure (100 psi/6.9 bar). Prior to testing with the synthetic mixture, all membranes were compacted with DI water for at least 2 hours, and the pure water permeance values were computed once the membranes reached steady state. The solution permeances of the membranes were estimated after collecting 60 mL of permeate for each membrane. All experimental results reported are based on at least three independent data points, except the results related to FIG. 26, where the average of two sets of membranes are reported.

### Evaluation of Membrane Transport and Separation Property

Water permeance (pure or wastewater) of the membrane was evaluated by using the following equation:

$$𝒫 = \frac{{J}_{W}}{Δ P}$$

where [symbol] is the water permeance of the membrane in L/m² hr bar or LMH/bar; J_{W} (L/m² hr or LMH) is the water flux (pure/wastewater) of the membrane measured using water flowrate (L/hr) over effective membrane filtration area (m²); and ΔP (bar) is the applied pressure (6.9 bar) used in this experiment.

Membrane rejection, R (%) was calculated by using this equation:

$$R = \frac{{C}_{a} - {C}_{p}}{{C}_{a}} \times 100 \%$$

Here, Cₐ (mg/L) is the average concentration of feed and retentate solution, whereas C_{P} (mg/L) is the permeate concentration.

Membrane permeance, P (%) was calculated by using this equation:

$$P = ( 100 - R ) \%$$

Membrane selectivity of component “A” over component “B” was measured using the following equation:

$${S}_{A / B} = \frac{\frac{{C}_{p , A}}{{C}_{p , B}}}{\frac{{C}_{F , A}}{{C}_{F , B}}}$$

[component A or B can be ammonium, potassium, or organic pollutant]

Here, C_{p,A} (mg/L) is the permeate concentration of component A; C_{p,B} (mg/L) is the permeate concentration of component B; C_{F,A} is the feed concentration of component A; and C_{F,B} is the feed concentration of component B.

### Membrane Characterization

Functional groups of polyelectrolyte multilayer membranes were analyzed using FTS 7000 Fourier Transform Infrared Spectrometer (FTIR) coupled with Varian Resolution Pro software within mid infrared region (4000-400 cm⁻¹). Polyelectrolyte multilayer (PEM) film thickness of membrane was measured using a Bruker DektakXT Stylus Profilometer. For this, PEM films were deposited on a glass substrate (Carolina Biological Supply Company, Burlington, North Carolina, USA). Prior to LbL deposition, glass slides were cleaned with ethanol for 20 minutes and exposed to oxygen plasma treatment (March PX-250 Plasma Asher) for 5 minutes at 50 W power to induce hydrophilicity and negative surface charge. Immediately after plasma treatment, the glass slides were subject to LbL dip coating experiments as per the method explained previously. PEM samples were fabricated in triplicates. Ten thickness measurements were taken for each polyelectrolyte sample, resulting in a total of 30 measurements for three replicates of each polyelectrolyte coating, from which the average and standard deviation values were reported (Table 14).

TABLE 14
Polyelectrolyte Multilayer Thickness
of PEM Membranes

| | PEM selective layer |
|---|---|
| Membranes | thickness (nm) |
| PDAC/SPS 5.5BL | 34 ± 3 |
| W NaCl coated | |
| NF270 | |
| PAH/PAA 8.5/3.5 | 130 ± 11 |
| 5.5BL coated | |
| NF270 | |
| PAH/PAA xGlu | 187 ± 28 |
| 5.5BL coated | |
| NF270 | |

### Zeta (ζ) Potential Analysis

In the context of membranes while direct measurements of the charge of stem plane—located between the interface of membrane surface and shear plane—is challenging, electrokinetic potential or zeta potential (charge of shear plane) is considered to be sufficient to predict membrane surface charge. Usually for the membranes, streaming potential analysis is conducted to determine the zeta potential for assessing charge-dependent separation performance. However, the widespread adoption of instruments dedicated to analyzing membrane streaming potential is hindered by their high cost, resulting in limited accessibility within laboratory settings. Fortunately, there exists an alternative method to predict membrane zeta potential by measuring the zeta potential of particles coated with similar materials used to fabricate the membrane itself. Membrane streaming potential is typically generated by the convective movement of charge at zero current, driven by the pressure gradient across the membrane fixed to a specific support, while for particles, zeta potential is measured due to the electrophoretic mobility of particles under an applied electric field. These two techniques, differing in their experimental setup—where streaming potential measurement involves a fixed membrane support and particle zeta potential measurement is based on the mobility of particles—may result in different magnitudes of potential values. However, their trends are very similar with values from both methods being closely aligned. In this study, zeta potential measurement of polyelectrolyte coated silica particle was employed to analyze the charge-dependent separation performance of polyelectrolyte membranes. Note that while standard deviations exist for these measurements, these are very usual and in fact may sometime result lower values than streaming potential measurements which was done on fixed membrane surfaces.

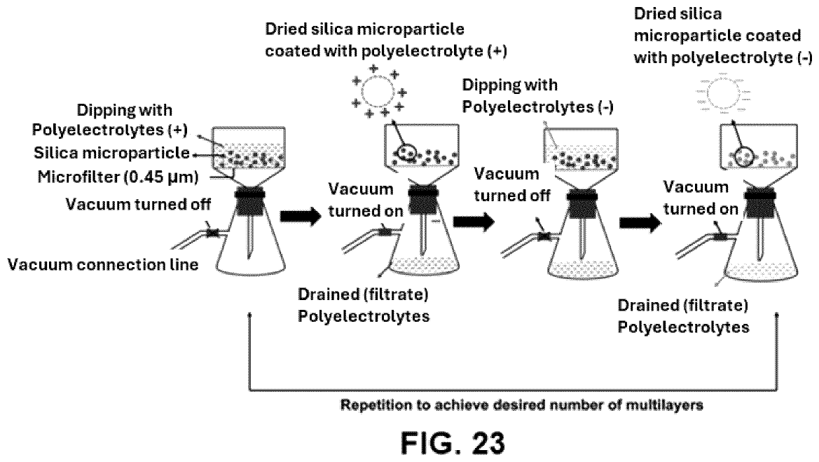

A Zetasizer Nano Series (Malvern Panalytical Ltd., UK) was used to determine the ζ potential of different polyelectrolyte coatings by taking average and standard deviation of three measurements. Polyelectrolyte multilayer was developed on top of silica microparticles (10 μm, ζ potential—16.8±3.9 mV). For the coating of polyelectrolytes, a vacuum filtration (PES 0.45 μm, Thermo Scientific, USA) method was developed, with the detail experimental procedure was shown in FIG. 23. For the first step, silica particles were immersed in positively charged polyelectrolytes for a specified duration with the vacuum turned off. After the completion of the desired time interval, the vacuum was turned on, causing the polyelectrolytes filtered and drained while the silica particles, now coated, were retained owing to their larger effective pore size relative to the filtration unit. For the second step, vacuum was tuned off (disconnected) again and the particle was dipped in negatively charged polyelectrolyte for desired time period. Following the conclusion of the designated time period, polyelectrolyte solution was then filtered again by turning the vacuum on. This process of dipping and draining was repeated until desired number of multilayers was achieved based on the methodology explained previously. Finally the coated polyelectrolyte particles were collected and dipped in DI water with pH adjusted to 7 prior to the measurement of their ζ potential.

### Measurements of Nutrients and Organic Pollutant Concentration

NH₄⁺ concentration was determined using a phenate method with a UV/Vis spectrophotometer (Perkin Elmer 3100 model). K⁺ concentration was measured using an Agilent Inductive Coupled Plasma Optical Emission Spectrometer (ICP OES 720). A Shimadzu TOC-L CSN series total organic carbon (TOC) analyzer was used to measure the organic pollutant concentration. The same TOC analyzer was also used to measure the concentration of different molecular weights organic components (glycerol, glucose, PEG300, and PEG400) used to observe rejections of modified and commercial NF membranes.

### Results and Discussion

A wide range of polyelectrolyte multilayer (PEM) membranes were fabricated on commercial NF 270 substrate using the LbL deposition technique, by varying the type of polyelectrolytes, pH used for deposition, and the nature of interaction between them. In this work, 5.5 bilayers of polyelectrolytes (1 bilayer=1 layer of polycation+1 layer of polyanion) were found to be optimum. Previous results have shown that when ended with positively charged outer layers, PEM membranes show desirable separation performance in terms of nutrient permeance and nutrient/organic selectivity and therefore, for this application, all multilayers were capped with positively charged outer layer. Previous work effectively demonstrated that in comparison to commercial NF membranes, polyelectrolyte modified NF membranes provide higher nutrient permeance and higher nutrient/organic selectivities under neutral pH conditions. These PEM membranes were primarily based on PDAC/SPS polyelectrolyte combination and the best permeability-selectivity trade off was achieved under the optimum conditions of using 5.5 bilayers with 0.5M added salt in the polyelectrolyte solutions. While the feasibility of PEM membranes has been shown in prior work, this paper is focused on identifying the underlying mechanisms of simultaneous nutrient permeance and organic rejection using this platform. For this work, the range of polyelectrolytes used, and their associated deposited conditions were expanded. Four specific sets of polyelectrolytes, as described previously, were used in this work utilizing a range of inter-polyelectrolyte interactions such as electrostatic, hydrogen bonding and covalent interactions. In addition to nutrient-organic separation, some proof of concept analyses on intra-nutrient (i.e. NH₄⁺/K⁺) separation is also discussed, by considering K⁺ as a co-nutrient with NH₄⁺ in the feed mixture. Intra-nutrient separation, as elaborated in detail later, is an extremely interesting scenario which involves an unusual desolvation-based separation mechanism for distinguishing between two same-sized nutrient ions (NH₄⁺ and K⁺).

### Characterization of PEM Membranes

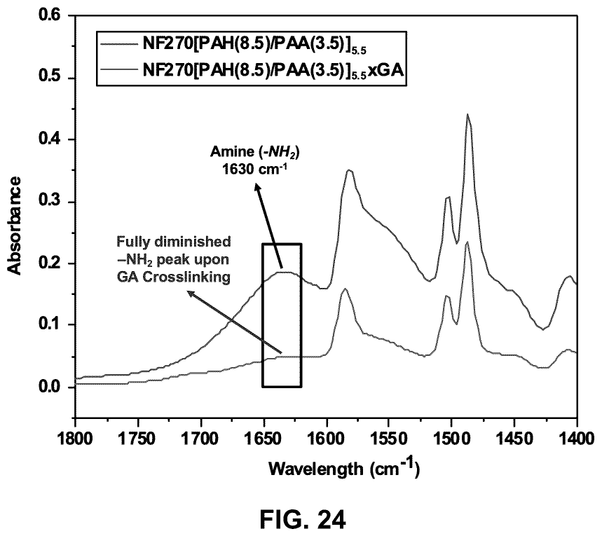

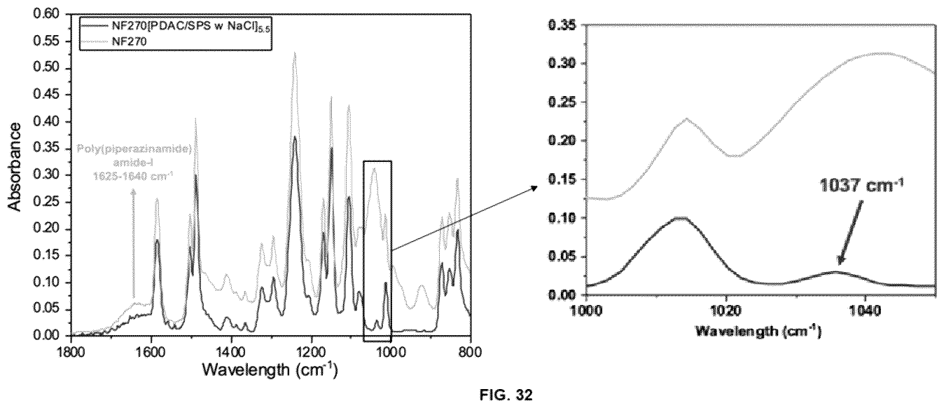

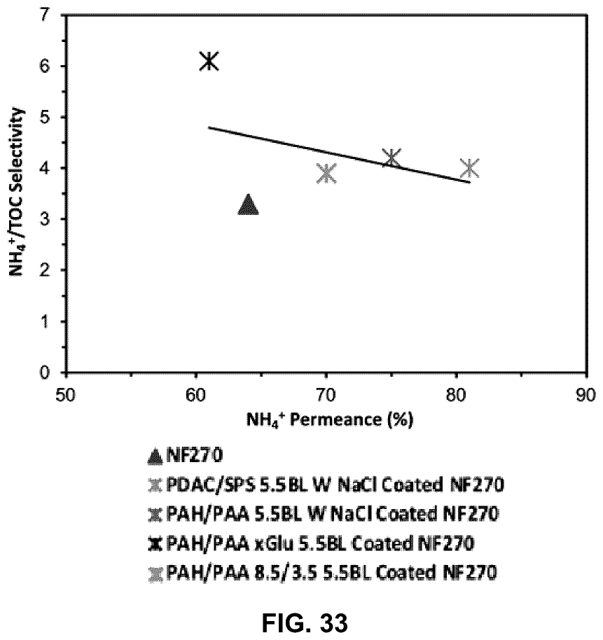

Of the different types of PEM membranes tested, the NF270[PAH(8.5)/PAA(3.5)]_{5.5}×GA membrane is the only kind which involves an additional post-deposition crosslinking step involving Glutaraldehyde (GA). The latter is known to form imines (C≡N) through a Schiff-base reaction with the primary amines of PAH. An FTIR analysis (FIG. 24) was done on uncross linked NF270[PAH(8.5)/PAA(3.5)]_{5.5} and crosslinked NF270[PAH(8.5)/PAA(3.5)]_{5.5}×GA membrane to confirm the presence of these imine bonds. Commercial NF270 membrane has a semi-aromatic poly(piperazinamide) selective layer, in which the peak for amide-I band (attributed to C═O stretching) lies between 1625˜1640 cm⁻¹ (FIG. 32), this result being consistent with the findings by Tang et al., Depending on the extent of crosslinking which relies on the concentration and time of GA Used, the —NH₂ peak can either be visible or completely diminished. Yang et al. have shown that the —NH₂ peak (1630 cm⁻¹) is fully diminished, when GA concentration is higher than 0.05M and the time of exposure exceeds 30 minutes. In theory, the C≡N peak is expected to lie within the 1645-1665 cm⁻¹ range; however, it is difficult to distinguish in the FTIR spectrum due to its very low intensity. In this case therefore, the effect of crosslinking was verified in terms of the disappearance of the —NH₂ peak, rather than the formation of the C≡N peak. In this work, the concentration of GA used for cross-linking was 0.15M and 90 mins were used for the crosslinking step. Consistent with Yang et al's findings, the —NH₂ peak was almost entirely diminished in the crosslinked PAH/PAA system, in comparison to the uncrosslinked counterpart, thus validating that the films were successfully crosslinked. The FTIR spectra of the ionic-crosslinked NF270[PDAC/SPS w NaCl]_{5.5} were also collected to confirm the deposition of PDAC/SPS multilayers on the NF 270.

### Membrane Separation Performance Analysis

Separation performance of polyelectrolyte multilayer membranes. Commercial NF membranes such as NF 270 and NF 90 show nutrient (NH₄⁺) permeances of ˜57% and ˜29% respectively, as discussed in prior work. When modified with [PDAC/SPS w NaCl]_{5.5} multilayers, the NH₄⁺ permeance increased ˜1.4× vs. bare NF 270 membrane, also resulting in ˜2× increase in NH₄⁺/TOC selectivity. Below, results from three other polyelectrolyte systems are discussed in terms of pure water flux, organic rejection and nutrient (NH₄⁺ and K⁺) permeation. As expected, surface modification of NF 270 membrane led to added resistance to permeation which resulted in decreased water and solution permeances as shown in Table 15. The extent of permeance decrease is however different, depending on the type of polyelectrolyte coatings. The electrostatically crosslinked combinations typically showed higher permeances than the hydrogen bonded multilayers and the covalently crosslinked multilayers showed the lowest permeances among all the membranes tested. These results align well with expectations, as the pure water and solution permeances follow an inverse trend to that of the thickness of the multilayer films. As reported in Table 13, the electrostatic systems are generally thinner (≤50 μm) whereas the covalent and hydrogen bonded systems are the thickest (≥130 μm). In addition to thickness, the effective porosity also plays an important role. Modifying the NF 270 surface with the covalent polyelectrolyte systems results in a marked reduction in effective porosity which reduces the water flux through the membranes but improves the organic rejection and nutrient/organic selectivities.

TABLE 15
Pure Water and Solution Permeances of Commercial
NF270 and Modified PEM Membranes

| | Pure water | Solution |
|---|---|---|
| | permeance | permeance |
| Membranes | (LMH/bar) | (LMH/bar) |
| NF270 | 15.5 ± 1.2 | 9.9 ± 0.7 |
| NF 270 [PDAC/SPS w NaCl]_{5.5} | 7.5 ± 0.7 | 6.0 ± 1.2 |
| NF 270[PAH/PAA w NaCl]_{5.5} | 13.5 ± 0.7 | 8.7 ± 0.7 |
| NF 270[PAH (8.5)/PAA(3.5)]_{5.5} | 2.4 ± 0.8 | 1.6 ± 0.7 |
| NF 270 [PAH (8.5)/PAA(3.5)]_{5.5}xGA | 0.8 ± 0.1 | 0.7 ± 0.2 |

The goal of the membrane process is to minimize organic transport, while permeating the majority of the nutrients (NH₄⁺ and K⁺). To develop a fundamental analysis of the underlying mechanisms, the complex process was deconvoluted into the two separate components—organic rejection and nutrient permeance, as discussed below.

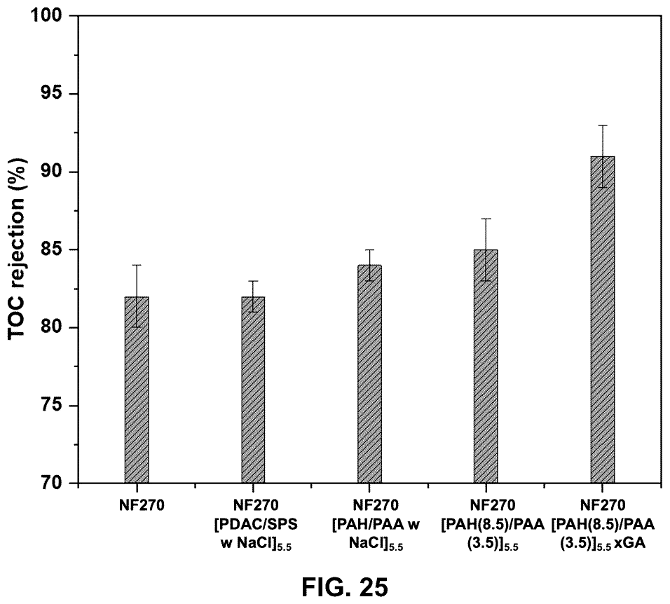

Organic rejection. To assess the rejection of organic pollutants (as TOC), three different organic compounds with varying number of carbon atoms (C2-C12), and a wide range of molecular weights (46 g/mole to 342 g/mole) were used. The molar ratios used were representative of actual AD supernatants from local wastewater plant at Morgantown, WV, USA. The bare NF 270 membrane, by itself, shows a substantially high (˜82%) organic rejection. Polyelectrolyte modification did not result in significant enhancement in organic rejection in most cases, and remained comparable to the bare NF270 membrane (rejection ˜82%) (FIG. 25). The only exception was the covalently crosslinked NF 270[PAH(pH 8.5)/PAA(pH 3.5)]_{5.5}×GA membrane, which results in significant reduction in the effective pore size and showed ˜12% higher organic rejection (˜91-93%) compared to other membranes. The thinner, ionically crosslinked membranes (NF 270[PAH/PAA w NaCl]_{5.5} and NF 270[PDAC/SPS w NaCl]_{5.5}) have similar porosities as the underlying NF 270 membrane and retains similar organic rejection as bare NF 270 membrane. The hydrogen bonded NF 270[PAH (8.5)/PAA(3.5)]_{5.5} membrane had a thick, loopy multilayer film; however, in the absence of GA crosslinking, the effective pore size was not significantly different from NF 270.

The organic rejection results suggest that covalent crosslinked membranes have lower effective pore sizes or a tighter pore size distribution vs uncrosslinked, ionic crosslinked and bare NF 270 membranes and showed the highest % organic removal via size exclusion. To validate this, direct, high-fidelity pore size measurements to differentiate among these PEM membranes could be performed but are challenging in nature. Therefore, as a more reliable alternative, a molecular weight cut off experiment (MWCO) was designed for validation. All membranes were tested with of 4 specific organics of different molecular weights: glycerol (92 g/mole), glucose (180 g/mole) and PEG molecules of two different molecular weights—300 g/mole and 400 g/mole, following the protocol discussed previously. As FIG. 26 shows, all PEM membranes and the commercial NF270 membrane showed practically no difference in % rejection for the organics ranging from ˜150 to ˜250 g/mole molecular weights. The difference is only apparent in case of smaller (<100 g/mol) organics, i.e. glycerol, wherein the crosslinked PEM membrane has a distinct separation performance (˜2× higher organic rejection) in comparison to the others. This thus serves to validate the hypothesis that crosslinking with GA helps to either provide a smaller effective pore size or a tighter pore size distribution. This outcome for the GA cross-linked PEM membrane is attractive for scenarios where rejection of low molecular weight organics is involved, as in the case of municipal wastewater plants. The results further demonstrate that size based exclusion is the dominant mechanism for organic rejection.

In this work, only neutral organics were considered, however, charged organics such as personal care products, perfluoro-components, organic acids, and bases could also be present in the feed matrix. It is anticipated that beyond a certain molecular weight, size exclusion effects will be the dominant rejection mechanisms even for charged organics. This is based on the fact that rejection rates for neutral organics were already >80% for all membranes considered here. Charge-based effects could however play a role in case of substances with lower molecular weight, since except the GA-crosslinked membranes, all membranes have lower % rejections for neutral organics.

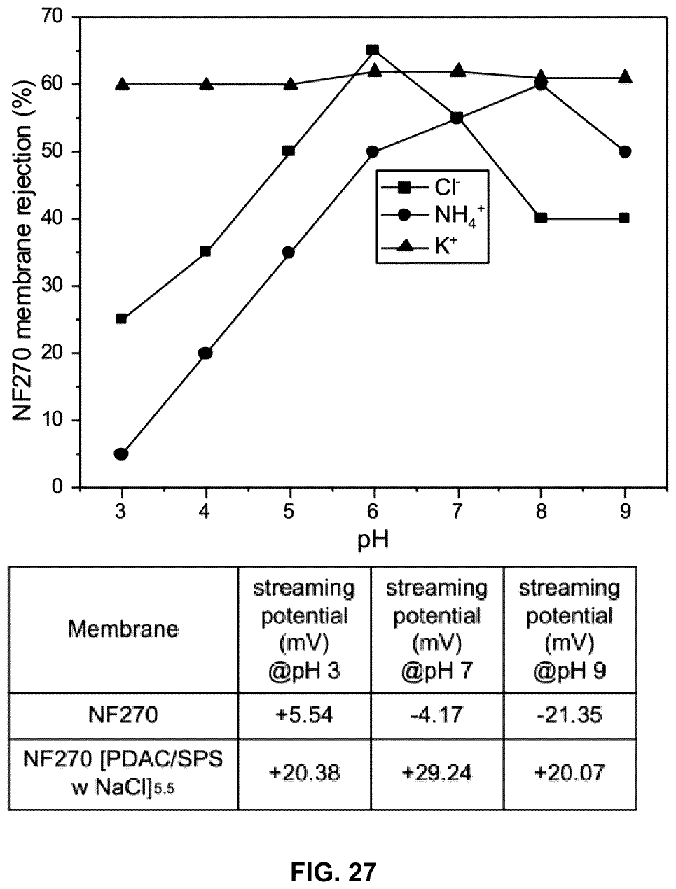

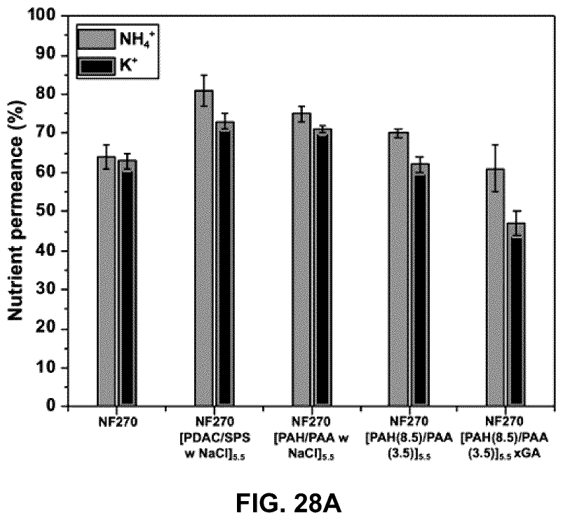

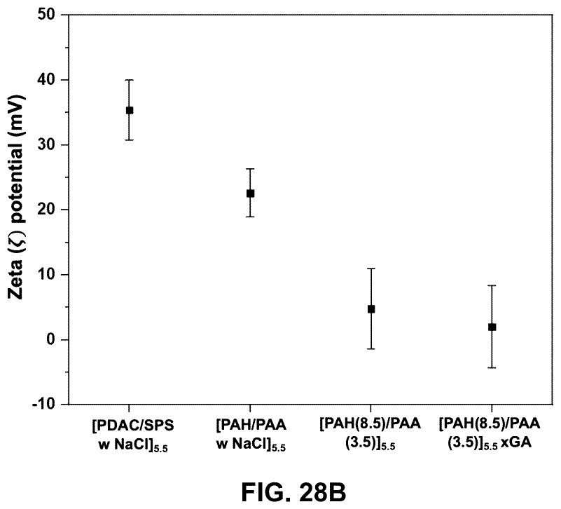

Nutrient permeance. While the GA-crosslinked membrane provided high organic rejection by virtue of its size exclusion abilities, the NF 270[PDAC/SPS w NaCl]_{5.5} membrane showed the highest nutrient (NH₄⁺, K⁺) permeance (FIG. 28A). Ammonia exists as neutral ammonia under alkaline condition and NH₄⁺ at pH<9.25; thus its permeation through a charged membrane is complex and relies on the solution pH. In this work, only NH₄⁺ was considered, since both the precipitation and the membrane separation process were carried out at neutral pH. The NF 270[PDAC/SPS w NaCl]_{5.5} membrane had surprisingly high NH₄⁺ permeance (˜82%), which was roughly 30% higher NH₄⁺ permeation compared to NF 270 membrane (˜63%) (FIG. 28A). As discussed in the context of FIG. 26, the effective pore size and pore size distribution of NF 270[PDAC/SPS w NaCl]_{5.5} is similar to that of unmodified NF 270, implying that nutrient permeance is primarily governed by charge-based interactions. In fact, such charge-based interactions are also reported in Pronk et al's prior work on NF 270 membranes, which showed lower NH₄⁺ retentions at acidic pH (˜10% at pH 3.0) and higher NH₄⁺ retentions (˜55%) at neutral pH (FIG. 27). This NH₄⁺ retention trend clearly correlates with the NF 270 membrane streaming potential which switches from negative to positive values, as the pH changes from neutral to acidic range (FIG. 27). The permeation of monovalent ions through charged membrane surfaces is complex and is said to be influenced by permeation of the co-ion, i.e. Cl⁻ in this case. Higher Cl⁻ permeation could be either due to its slightly higher diffusion coefficients (2.030×10⁻⁹ m²/s) vs. NH₄⁺ (1.980×10⁻⁹ m²/s) and K⁺ (1.960×10⁻⁹ m²/s), or due to electrostatic attraction with the positively charged outer surface. While the exact mechanism is not well known, high Cl⁻ diffusion results in high NH₄⁺ and K⁺ diffusion as well, to maintain electroneutrality. As Pronk et al's data with NF 270 membrane shows, the NH₄⁺ permeation trend closely mirrors that of Cl⁻ with respect to pH, it is interesting to note, however, that K⁺ permeation is largely pH independent and is not influenced by Cl⁻ permeation, despite K⁺ being same-sized as NH₄⁺. This could be attributed to the fact that K⁺ diffusion is lower than NH₄⁺ due to difference in solvation properties between the two ions—this topic, in fact, has been discussed in detail elsewhere in this disclosure, in the context of intra-nutrient separation. In case of commercial NF 270 membrane, high nutrient permeance is possible under acidic conditions and this would require pH change of the feed solution. A positively charged membrane such as NF 270[PDAC/SPS w NaCl]_{5.5} on the other hand, could facilitate high nutrient permeance at neutral pH, as demonstrated in FIGS. 28A-28B. The outer layer, PDAC, is a strong polyelectrolyte and is independent of the solution pH and this property helps to maintain a stable streaming potential over a wide pH range, as noted in FIG. 27. These results thus show a clear advantage of positively charged PEM membranes over NF 270 membrane.

While NH₄Cl and KCl were used in this study to investigate nutrient permeance mechanisms, the results are expected to be different, if the corresponding sulfates ((NH₄)₂SO₄ and K₂SO₄) were used instead of chlorides. Unmodified NF membranes with negatively charged outer surfaces, typically reject divalent ions such as SO₄²⁻ via Donnan exclusion, in the process also increasing the retention of NH₄⁺ and K⁺. Positively charged PEM membranes could provide an advantage in this case by reducing the possibility of charge-based repulsion of SO₄²⁻ ions. In any case, for a number of feed systems including municipal wastewater, the SO₄²⁻ concentration (92-320 mg/L) is 4-5× lower than the typical Cl⁻ concentration (391-900 mg/L).

In FIG. 28A, the performance of 4 different PEM membranes are shown in terms of NH₄⁺ and K⁺ permeance. The NF 270[PDAC/SPS w NaCl]_{5.5} and NF 270[PAH/PAA w NaCl]_{5.5} membranes showed the highest NH₄⁺ and K⁺ permeance and this could be attributed to the fact that these systems have the highest magnitudes of zeta potential, as shown in FIG. 28B. PDAC/SPS is a strong polyelectrolyte system and in presence of NaCl, show >+30 mV zeta potential. PAH and PAA polyelectrolytes are fully ionized in the presence of NaCl where the outermost layer must have a high magnitude of surface charge due to extrinsic charge compensation. Under the pH conditions of 8.5 and 3.5, PAH and PAA are partially ionized, and they are known to form thick, loopy films, which thus contributes to provide a high resistance to ion permeation. When these films are crosslinked, as in the case of NF 270[(PAH(8.5)/PAA(3.5)]_{5.5}×GA, the resulting membranes showed the lowest nutrient permeances. It is believed that in both these cases, the films do not have a strong positive charge as depicted in FIG. 28B and, in fact, usually for PEM film systems, the charge on the film has been reported to not alternate in many cases and remained same when PEM films undergo chemical crosslinking. This phenomenon was also evident in these cases, as shown in FIG. 28B. This further shows that nutrient permeance is surface charge reliant and based on the results observed at FIGS. 28A-28B, permeance is possibly influenced by the magnitude of the outermost layer surface charge. A surprising trend to note in case of the NF 270[(PAH(8.5)/PAA(3.5)]_{5.5}×GA membrane is the distinct difference in NH₄⁺ and K⁺ permeances, even though the hydrated radii of these ions are exactly same (0.33 nm). As discussed in detail elsewhere in this disclosure, this is believed to be due to an unusual desolvation phenomenon that occurs specifically in crosslinked systems and could be potentially modulated by the degree and extent of crosslinking.

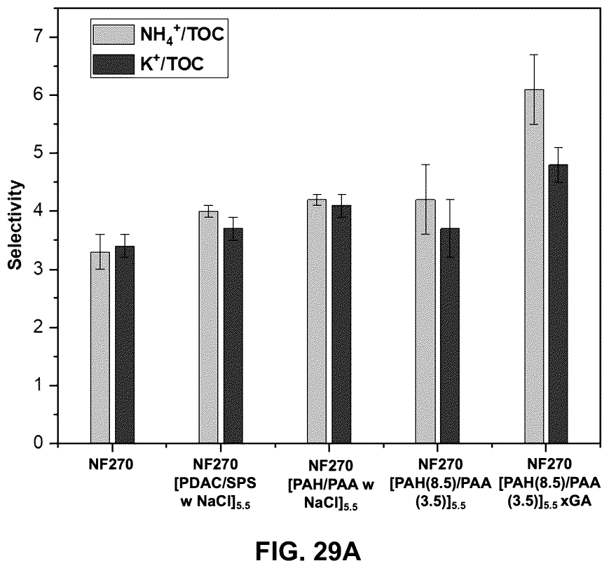

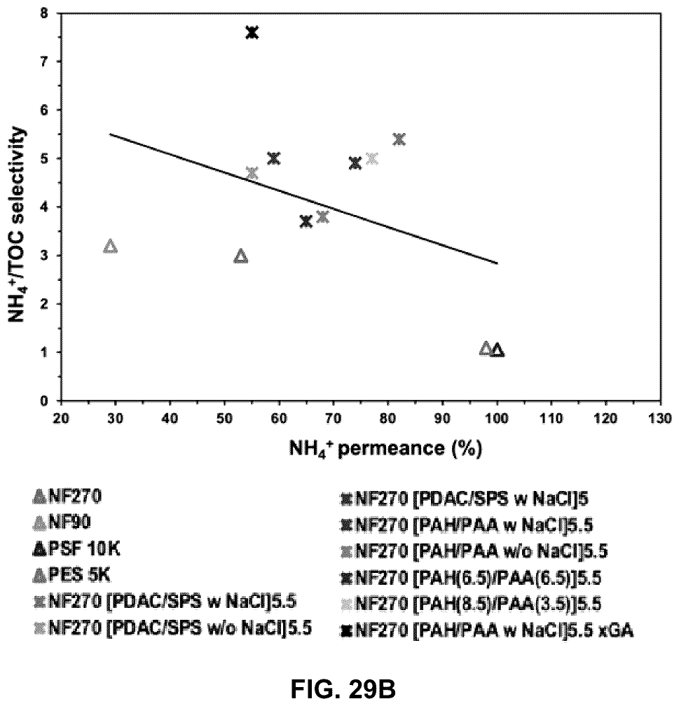

Nutrient organic separation trade-off in PEM membranes and insights into new membrane design. All PEM membranes tested in this work exhibited higher nutrient (NH₄⁺, K⁺)/TOC selectivity (˜4 to ˜6) compared to commercial NF270 membrane (˜3), as shown in FIGS. 29A-29B. The NF 270[PAH(8.5)/PAA(3.5)]_{5.5}×GA membrane specifically showed ˜2×NH₄⁺/TOC selectivity and ˜1.4×K⁺/TOC selectivity in comparison to NF 270—the highest among the membranes tested in this work. These results thus demonstrate a wide range of properties that can be achieved using the membrane surface modification strategy via tuning the types of polyelectrolytes, their deposition conditions and, in turn, the nature of inter-polyelectrolyte interactions (ionic/hydrogen bonding/covalent). The systems described here, in no way, represent an exhaustive list of polyelectrolytes and LbL conditions that could be used, and therefore opportunities to further improve the membrane performance exist.

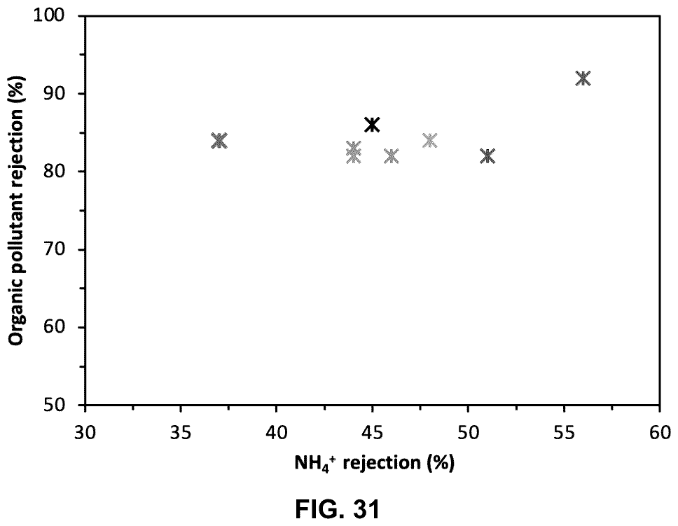

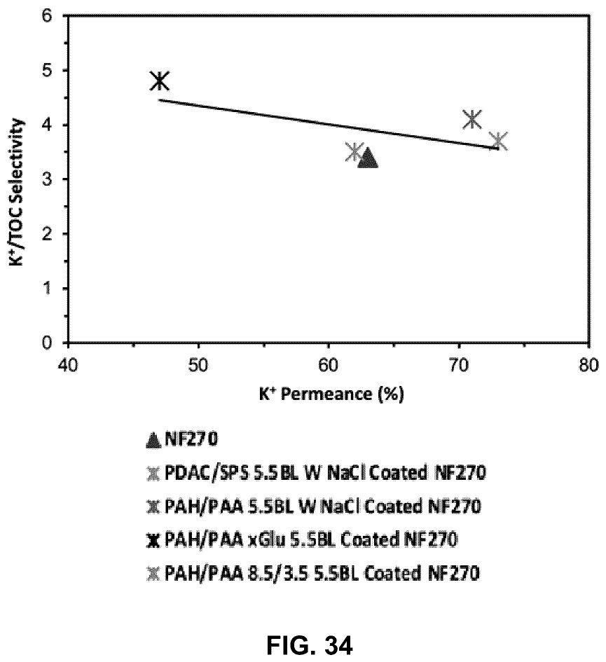

As discussed previously, the nutrient permeance mechanism is distinct from that of organic rejection—the former being influenced by surface charge and the latter by size-based exclusion. A trade-off nature is evident wherein membranes that display high nutrient permeance show lower nutrient (NH₄⁺, K⁺)/organic selectivities and vice-versa. FIG. 29B clearly demonstrates this trend, wherein the performance of a variety of PEM membranes and a set of commercial membranes are displayed in terms of % NH₄⁺ permeance and NH₄⁺/TOC selectivity. In addition to the PEM membranes described in detail here, the results from four other polyelectrolyte combinations (details in FIG. 31) are included in this figure—NF 270[PDAC/SPS w NaCl]₅, NF 270[PDAC/SPS w/o NaCl]_{5.5}, NF 270[PAH (pH 6.5)/PAA (pH 6.5)]_{5.5} and NF 270[PAH(pH 4)/PAA(pH 10) w/o NaCl]_{5.5}. The trends are similar for K⁺ as well (FIG. 34). The results from two commercial NF (NF 270, NF 90) and two UF (Polyethersulfone (PES) MWCO 5,000 g/mole and Polysulfone (PSf) MWCO 10000 g/mole) membranes were also added as benchmarks. The UF membranes showed ˜100% NH₄ permeance and ˜0% TOC retention, with no nutrient/organic pollutant selectivity.

Permeability-selectivity trade off curves are very common in case of gas separations and ion separations and they serve as important frameworks to guide the design of membrane materials. In fact, the upper bound trade-off relationship for gas separation led to the conclusion that both chain stiffness and inter-chain free volume are necessary for polymer membranes to overcome the permeability-selectivity trade-off, and this principle has continued to guide gas separation membrane material design till today. The results in this paper allow for developing the first-of-its-kind nutrient-organic trade-off curve and is similarly aimed at guiding rational membrane design for nutrient recovery. The origin of this trade-off nature, especially for polyelectrolyte-based membrane arises from the fact that strong surface charge is necessary for high nutrient permeance, while crosslinking of polyelectrolytes leads to high nutrient/organic selectivities. Covalent crosslinked polyelectrolyte membranes had lower surface charge compared to ionic-crosslinked counter parts as evident from the results pertaining to FIG. 28B, however, due to their lower effective pore size these membranes were able to achieve a high organic pollutant retention. Thus membrane materials where surface charge and size exclusion properties are synergized, are expected to overcome the permeability-selectivity trade-off. For polyelectrolyte-based modification, this could imply controlled chain crosslinking that retains some of the charged functionalities and crosslink the rest to create organic-rejecting size exclusion domains. This framework could also aid in synthesis of new polyelectrolytes with two or more functional entities along the polymer backbone, one of which could be tuned to provide surface charge density and the remaining crosslinked for size exclusion purposes. This principle would also be useful to adapt to other types of materials such as crosslinked zwitterionic copolymer membranes which, by virtue of the charged nanochannels present, could achieve both size exclusion and charge-based transport. Finally, switching the LbL substrate to a more porous membrane, e.g. UF membranes with inherently high nutrient permeances, presents an additional route to overcoming the trade-off.

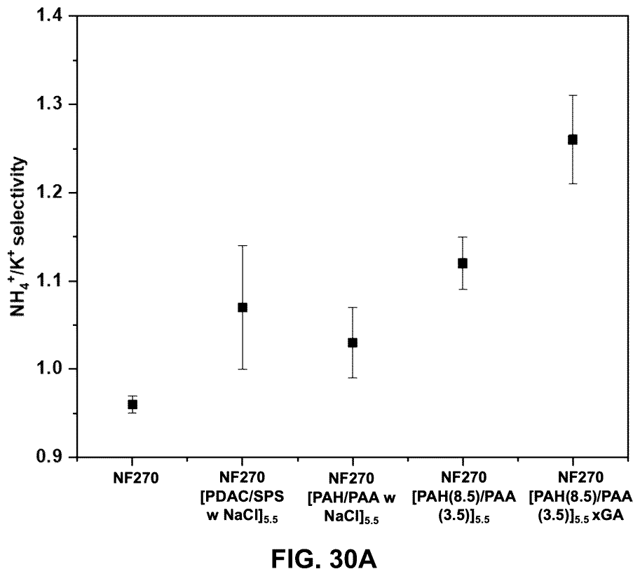

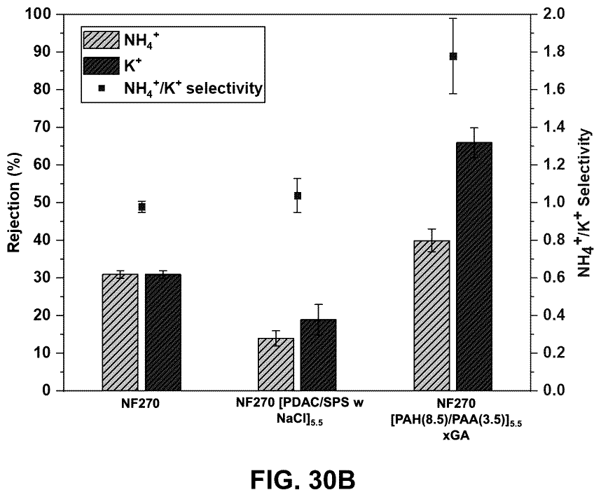

Intra-nutrient selectivity of PEM membranes. Herein, the intra-nutrient (NH₄⁺/K⁺) selectivities that are exhibited by the NF 270[PAH (8.5)/PAA (3.5)]_{5.5}×GA membranes are highlighted. While the selectivities (˜1.3-1.5) are low (FIG. 30A), the ability to distinguish between nutrients is still of fundamental interest since these nutrients are exactly same-sized (0.33 nm) with very similar hydration energies (˜10 kJ/mol difference). To deconvolute any potential effects of organics on these results, three specific membranes—the bare NF 270, NF 270[PDAC/SPS w NaCl]_{5.5} and NF 270[PAH (8.5)/PAA (3.5)×GA]_{5.5} were tested with a binary NH₄⁺ (550-650 mg/L):K⁺ (60-80 mg/L) synthetic solution. The same trend in performance was observed for this binary mixture as was the case for the original synthetic mixture, as shown in FIG. 30B. In fact in the absence of organic matter, NH₄⁺/K⁺ selectivity of GA crosslinked membrane was ˜1.8, while NF270 and NF 270[PDAC/SPS w NaCl]_{5.5} membrane maintained almost similar selectivities close to ˜1. The envisioned mechanism could be derived from prior molecular dynamics simulation results described by Aydin et al. It is important to note that the figure shown here is a simplified representation of water molecules surrounding the first solvation shell, however, the actual scenario may be more intricate and could possibly involve multiple solvation shells. The hydration energy of NH₄⁺ ion is only 10 kJ/mole lower than K⁺ however, the local solvation structure is different in the two ions. Specifically, K⁺ has ˜6.8 tightly bound water molecules in the first solvation shell, while NH₄⁺ has ˜5.2 tightly bound water molecules. K⁺, therefore has a higher solvation strength indicating that it is harder to “desolvate” than NH₄⁺. It is speculated that transport through the crosslinked domains of the [PAH (8.5)/PAA 3.5)×GA]_{5.5} under transmembrane pressure forces the NH₄⁺ ion to partially desolvate, while the water shell around K⁺ ion remains intact. This unusual desolvation-induced separation enabled by the crosslinked membranes is envisioned to lead to NH₄⁺/K⁺ selectivity >1. This implies that the NF270 membrane and the ionic crosslinked membranes lack such confinement domains which could force both the NH₄⁺ and K⁺ ions to desolvate in a similar manner. Prior work by Yang et al. has shown that the cross-linking density of PEM films can be altered by varying the GA concentration and the duration of the cross-linking process. Based on this hypothesis, it should be possible to fabricate PEM membranes that can achieve higher intra-nutrient (NH₄⁺/K⁺) selectivities compared to the values reported in this work. On a fundamental level, this strategy provides new opportunities and design principles for developing membranes with high ion-ion selectivities. On a practical level, this technology can be adapted to the needs of diverse fertilizer manufacturers, where different N:P:K ratios are desirable based on the final application. Thus, the intra-nutrient selectivity aspect adds another dimension to membrane design, in addition to overall nutrient permeance and organic rejection.

### CONCLUSION

This study demonstrates the potential of polyelectrolyte membranes to achieve concurrent nutrient permeance and organic pollutant retention from nutrient-rich resources under neutral pH conditions. The findings of this study revealed that the mechanism governing nutrient permeance differs from organic pollutant rejection, with the former being affected by surface charge and the latter by size-based exclusion. In particular, ionically crosslinked PEM membranes, modified with PDAC/SPS polyelectrolytes, facilitates higher nutrient permeation (˜30% higher compared to commercial NF270 membranes) due to their high positive surface charge. In addition, covalently crosslinked PEM membranes, modified with PAH/PAA and glutaraldehyde, demonstrates enhanced nutrient/organic selectivity (up to ˜2× compared to NF270) owing to their size-exclusion mechanism and increased organic pollutants rejection. The findings of this study helps with the development of a first-of-its-kind nutrient-organic trade-off curve aiming to rational membrane design for nutrient recovery applications. These results suggest that achieving a synergistic combination of surface charge and size exclusion properties in a specific membrane material is essential to overcome this permeability-selectivity trade-off barrier. Finally, herein are provided insights into the intra-nutrient separation mechanism, demonstrating how covalently crosslinked membranes effectively separate similarly sized nutrients (NH₄⁺ and K⁺) based on their distinct desolvation properties. The conclusions drawn from this study will benefit the membrane community in directing the design of membranes, specifically tailored for nutrient recovery applications. This approach eliminates organic pollutants and allows for the recovery of adjustable proportions of nutrients tailored to specific fertilizing needs, all without the need to alter wastewater pH and thereby minimizing additional chemical costs.

### Characterization of PEM Membranes

FIG. 32 shows the FTIR images of NF270 and ionic-crosslinked NF270[PDAC/SPS w NaCl]_{5.5} membrane. In the case of the PDAC/SPS coated membrane, an additional peak was observed at ˜1037 cm⁻¹ due to sulfonate stretching of SPS and C—N stretching of PDAC, confirming successful deposition of PDAC and SPS onto NF270 membrane. Raw zeta potential data is provided in Table 16 below.

TABLE 16
Raw Zeta Potential Data of Silica and Polyelectrolyte-Coated Silica Particle

| | | | | | | | | | |
|---|---|---|---|---|---|---|---|---|---|
| Silica | Run 1 | −24.1 | −22.4 | −21.7 | | | | | |
| | Run 2 | −16 | −16.7 | −17.2 | | | | | |
| | Run 3 | −14.5 | −14.4 | −14.5 | | | | | |
| | Run 4 | −13.3 | −12.9 | −13.3 | | | | | |
| | Average ± | | | −16.8 ± | | | | | |
| | SD | | | 3.9 | | | | | |
| [PDAC/SPS w NaCl]_{5.5} | Run 1 | 34.5 | 36.6 | 37.2 | 35.7 | 37.9 | 35.3 | | |
| | Run 2 | 25.6 | 29.5 | 36.6 | 41 | 43 | 42.9 | | |
| | Run 3 | 31.5 | 29.3 | 38.6 | 34.2 | 35 | 33.1 | | |
| | Average ± | | | | | | 35.4 ± | | |
| | SD | | | | | | 4.6 | | |
| [PAH/PAA w NaCl]_{5.5} | Run 1 | 22.6 | 21.4 | 19.4 | 24.9 | 24.2 | 31 | | |
| | Run 2 | 26.6 | 27.4 | 27.4 | 23.4 | 20.7 | 19.6 | | |
| | Run 3 | 22.3 | 18.9 | 20.1 | 19.5 | 19.4 | 17.5 | | |
| | Average ± | | | | | | 22.6 ± | | |
| | SD | | | | | | 3.7 | | |
| [PAH(8.5)/PAA(3.5)]_{5.5} | Run 1 | 1.1 | 0.394 | 0.483 | 0.0807 | 0.246 | 0.16 | 8.85 | |
| | | 11 | 8.35 | 10.9 | 10.4 | 10.8 | 26.3 | 12.2 | 11.5 |
| | Run 2 | 1.35 | 0.891 | 0.823 | 2.68 | 0.434 | 1.3 | | |
| | Run 3 | 1.1 | 0.379 | 0.625 | 0.972 | 1.54 | 5.47 | | |
| | Average ± | | | | | | | | 4.8 ± |
| | SD | | | | | | | | 6.2 |
| [PAH(8.5)/PAA(3.5)]_{5.5} × | Run 1 | −0.0931 | −0.503 | −0.52 | −9.36 | −11.9 | −8.42 | 6.05 | |
| GA | | 15.3 | 13.6 | 7.11 | 8.34 | 5.64 | | | |
| | Run 2 | 1.36 | 1.05 | −0.108 | 2.56 | 5.84 | 6.38 | | |
| | Run 3 | 2.93 | 1.01 | 2.56 | −0.399 | 2 | −2.47 | | |
| | Average ± | | | | | | | 2.0 ± | |
| | SD | | | | | | | 6.3 | |

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Adamczyk-Szabela, D, The Impact of Soil pH on Heavy Metals Uptake and Photosynthesis Efficiency in Melissa officinalis, Taraxacum officinalis, Ocimum basilicum, Molecules. 27 (2022), 4671.
2. AI-Borno A, et al. The temperature dependence of the solubility product constant of vivianite. Geochim Cosmochim Acta. 1994; 58(24), 5373-5378.
3. An, Q et al, Covalent layer-by-layer films: Chemistry, design, and multidisciplinary applications, Chem. Soc. Rev. 47 (2018). doi:10.1039/c7cs00406k.
4. Angelini P, et al. Materials for Separation Technologies: Energy and Emission Reduction Opportunities. DOE, EERE Office; 2005:103.
5. Anlauf, A. An extractive bioeconomy?Phosphate mining, fertilizer commodity chains, and alternative technologies, Sustain. Sci. 18 (2023). doi:10.1007/s11625-022-01234-8.
6. Anwar, R. Elucidating Biogeochemical Reactions of Iron for Ammonium Removal and Nutrient Recovery from Wastewaters: Moving toward Sustainable Wastewater Management, West Virginia University, 2022.
7. Arienzo, M et al, A review of the fate of potassium in the soil-plant system after land application of wastewaters, J. Hazard. Mater. 164 (2009), 415-422.
8. Aydin, F. et al. Pham, Similarities and differences between potassium and ammonium ions in liquid water: A first-principles study, Phys. Chem. Chem. Phys. 22 (2020), 2540-2548.
9. Baird R, et al. Standard Methods for the Examination of Water and Wastewater (23rd edition). Washington D.C.: American Public Health Association, 2017.
10. Battistoni P, et al. Struvite crystallization in sludge dewatering supernatant using air stripping: the new full scale plant at Treviso (Italy) sewage works. In: 2nd International Conference on Phosphorus Recovery for Recycling from Sewage and Animal Wastes; 1998.
11. Boo C, et al, Elimelech M. High performance nanofiltration membrane for effective removal of perfluoroalkyl substances at high water recovery. Environ Sci Technol. 2018; 52:7279-7288.
12. Capodaglio A G, et al. Energy issues in sustainable urban waste-water management: use, demand reduction and recovery in the urban water cycle. Sustainability. 2020; 12:266.
13. Cho, K. L. et al, Chlorine resistant glutaraldehyde crosslinked polyelectrolyte multilayer membranes for desalination, Adv. Mater. 27 (2015), 2791-2796.
14. Covarrubias, S A et al, Alginate beads provide a beneficial physical barrier against native microorganisms in wastewater treated with immobilized bacteria and microalgae, Appl. Microbiol. Biotechnol. 93 (2012). doi:10.1007/s00253-011-3585-8.
15. Daramola, D A et al, Energy Demand of Nitrogen and Phosphorus Based Fertilizers and Approaches to Circularity, ACS Energy Let. 8 (2023). doi:10.1021/acsenergylett.2c02627.
16. Decher G, et al. Layer-by-layer assembled multicomposite films. Curr Opin Colloid Interface Sci. 1998; 3(1), 32-39.
17. Dodds, W K et al, Policy Analysis Policy Analysis Eutrophication of U.S. Freshwaters: Damages, Environ. Sci. Technol. 43 (2009), 12-19.
18. Erisman J W, et al. How a century of ammonia synthesis changed the world. Nat Geosci. 2008; 1:636-639.
19. Freeman, BD. Basis of permeability/selectivity tradeoff relations in polymeric gas separation membranes, Macromolecules. 32 (1999). doi:10.1021/ma9814548.
20. Fujimoto N, et al. Phosphorus fixation in the sludge treatment system of a biological phosphorus removal process. In: Water Science and Technology. Vol 23; 1991, 635-640.
21. Gerardo, M I et al, Moving towards sustainable resources: Recovery and fractionation of nutrients from dairy manure digestate using membranes, Water Res. 80 (2015), 80-89.
22. Ghavam, S et al, Sustainable Ammonia Production Processes, Front. Energy Res. 9 (2021). doi:10.3389/fenrg.2021.580808.
23. Hafiz, M et al, A hybrid nf-fo-ro process for the supply of irrigation water from treated wastewater: Simulation study, Membranes (Basel). 11 (2021). doi:10.3390/membranes11030191.
24. Huang H, et al. Recovery of phosphate and ammonia nitrogen from the anaerobic digestion supernatant of activated sludge by chemical precipitation. J Clean Prod. 2015; 102:437-446.
25. Huang, M H et al, Chemical composition of organic matters in domestic wastewater, Desalination. 262 (2010). doi:10.1016/j.desal.2010.05.037.
26. Hwang S J. Eutrophication and the ecological health risk. Int J Environ Res Publ Health. 2020; 17:6332.
27. Jaffer Y, et al. Potential phosphorus recovery by struvite formation. Water Res. 2002; 36:1834-1842.
28. Jaiswal, D K et al, Potassium as an important plant nutrient in sustainable agriculture: A state of the art, in: Potassium Solubilizing Microorg. Sustain. Agric., 201, pp. 21-29.
29. Jia, G et al, Applying a chemical equilibrium model for optimizing struvite precipitation for ammonium recovery from anaerobic digester effluent, J. Clean. Prod. 147 (2017), 297-305.
30. Kamcev, J. Reformulating the permselectivity-conductivity tradeoff relation in ion-exchange membranes, J. Polym. Sci. 59 (2021). doi:10.1002/pol.20210304.
31. Kyriakou V, et al. An electrochemical Haber-Bosch process. Joule. 2020; 4:142-158.
32. Langhans C, et al. Phosphorus for sustainable development goal target of doubling smallholder productivity. Nat Sustain. 2022; 5:57-63.
33. Le, V G et al, Applying a Novel Sequential Double-Column Fluidized Bed Crystallization Process to the Recovery of Nitrogen, Phosphorus, and Potassium from Swine Wastewater, ACS ES T Water. 1 (2021), 707-718.
34. Li, B, et al, Ecological footprint analysis of the phosphorus industry in China, Environ. Sci. Pollut. Res. 29 (2022). doi:10.1007/s11356-022-20878-8.
35. Liu J, et al. Recovery of phosphate from aqueous solutions via vivianite crystallization: thermodynamics and influence of pH. Chem Eng J. 2018; 349:37-46.
36. Lorick D, et al. Effectiveness of struvite precipitation and ammonia stripping for recovery of phosphorus and nitrogen from anaerobic digestate: a systematic review. Environ Evid. 2020; 9:1-20.
37. Lounder, S J et al, Interaction-based ion selectivity exhibited by self-assembled, cross-linked zwitterionic copolymer membranes, Proc. Natl. Acad. Sci. U.S.A 118 (2021). doi:10.1073/pnas.2022198118.
38. Moradi, M R et al, Polyelectrolyte multilayers modification of nanofiltration membranes to improve selective separation of mono- and multivalent cations in seawater brine, J. Memb. Sci. 691 (2024). doi:10.1016/j.memsci.2023.122224.
39. Moragaspitiya C, et al. Optimization of mesophilic anaerobic digestion of a conventional activated sludge plant for sustainability. Alex Eng J. 2019; 58:977-987.
40. Mulder M, et al. Basic Principles of Membrane Technology. Springer Science and Business Media; 1996.
41. Munch E V, et al. Controlled struvite crystallisation for removing phosphorus from anaerobic digester sidestreams. Water Res. 2001; 35:151-159.
42. Ohlshi M, et al. Separation techniques for high-molecular-mass proteins. J Chromatogr B. 2002; 771:49-66.
43. Oluwole, A O et al, Pharmaceuticals and personal care products in water and wastewater: a review of treatment processes and use of photocatalyst immobilized on functionalized carbon in AOP degradation, BMC Chem. 14 (2020). doi:10.1186/s13065-020-00714-1.
44. Orner K D, et al. Improving life cycle economic and environmental sustainability of animal manure management in marginalized farming communities through resource recovery. Environ Eng Sci. 2021; 38: 310-319.
45. Ouikhalfan, M et al, Toward Net-Zero Emission Fertilizers Industry: Greenhouse Gas Emission Analyses and Decarbonization Solutions, Energy and Fuels. 36 (2022), 4198-4223.
46. Peeters, J M M et al, Streaming potential measurements as a characterization method for nanofiltration membranes, Colloids Surfaces A Physicochem. Eng. Asp. 150 (1999). doi:10.1016/S0927-7757(98)00828-0.
47. Pei-Jen C, et al. The Solubility Product of Ferrous Phosphate. Environ Lett. 1974; 6(4), 287-296.
48. Piash, K S et al, Integrating Chemical Precipitation and Membrane Separation for Phosphorus and Ammonia Recovery from Anaerobic Digestate, AIChE J. (2022), e17869.
49. Priambodo R, et al. Phosphorus recovery as ferrous phosphate (vivianite) from wastewater produced in manufacture of thin film transistor-liquid crystal displays (TFT-LCD) by a fluidized bed crystallizer (FBC). RSC Adv. 2017; 7:40819-40828.
50. Pronk W, et al. Nanofiltration for the separation of pharmaceuticals from nutrients in source-separated urine. Water Res. 2006; 40:1405-1412.
51. Prot T, et al. Full-scale increased iron dosage to stimulate the formation of vivianite and its recovery from digested sewage sludge. Water Res. 2020; 182:115911.
52. Prot T, et al. Magnetic separation and characterization of vivianite from digested sewage sludge. Sep Purif Technol. 2019; 224:564-579.
53. Qadir, M et al, Global and regional potential of wastewater as a water, nutrient and energy source, Nat. Resour. Forum. 44 (2020). doi:10.1111/1477-8947.12187.
54. Rahman, M A et al, Importance of mineral nutrition for mitigating aluminum toxicity in plants on acidic soils: Current status and opportunities, Int. J. Mol. Sci. 19 (2018), 3073.
55. Ray, H et al, Rejection of nitrogen species in real fresh and hydrolyzed human urine by reverse osmosis and nanofiltration, J. Environ. Chem. Eng. 8 (2020), 103993.
56. Reurink, D M et al, Role of Polycation and Cross-Linking in Polyelectrolyte Multilayer Membranes, ACS Appl. Polym. Mater. 2 (2020). doi:10.1021/acsapm.0c00992.
57. Robeson, LM. Correlation of separation factor versus permeability for polymeric membranes, J. Memb. Sci. 62 (1991). doi:10.1016/0376-7388(91)80060-J.
58. Rosenqvist I T. Formation of vivianite in holocene clay sediments. LITHOS. 1970; 3(4), 327-334.
59. Rothe M, et al. The occurrence, identification and environmental relevance of vivianite in waterlogged soils and aquatic sediments. Earth-Sci Rev. 2016; 158:51-64.
60. Sanyal O, et al. Cause and effects of hyperskin features on carbon molecular sieve (CMS) membranes. J Membr Sci. 2018; 551:113-122.
61. Sanyal O, et al. Design of ultrathin nanostructured polyelectrolyte-based membranes with high perchlorate rejection and high permeability. Sep Purif Technol. 2015; 145:113-119.
62. Sanyal O, et al. Designing fouling-resistant clay-embedded polyelectrolyte multilayer membranes for wastewater effluent treatment. J Membr Sci. 2016; 512:21-28.
63. Sanyal O, et al. Development of polyelectrolyte multilayer membranes to reduce the COD level of electrocoagulation treated high-strength wastewater. J Membr Sci. 2015; 496:259-266.
64. Schlenoff, JB. Charge Balance and Transport in Polyelectrolyte Multilayers, in: Multilayer Thin Film., 2003, pp. 99-132.
65. Schuetz, P et al, Copper-Assisted Weak Polyelectrolyte Multilayer Formation on Microspheres and Subsequent Film Crosslinking, Adv. Funct. Mater. 13 (2003), 929-937.
66. Shan W, et al. Polyelectrlyte multilayer films as backflushable nanofiltration membranes with tunable hydrophilicity and surface charge. J Membr Sci. 2010; 349:268-278.
67. Siciliano A, et al. Advances in struvite precipitation technologies for nutrients removal and recovery from aqueous waste and wastewater. Sustainability. 2020; 12:7538.
68. Singer P, et al. Treatability analysis of digester supernatant and other return flows to improve wastewater treatment plant efficiency. Water Resources Research Institute of the University of North Carolina. 1982.
69. SINGER PC. Anaerobic control of phosphate by ferrous iron. J Water Pollut Control Fed. 1972; (4), 663-669.
70. Smith, C et al, Current and future role of Haber-Bosch ammonia in a carbon-free energy landscape, Energy Environ. Sci. 13 (2020). doi:10.1039/c9ee02873k.
71. Stanton B W, et al. Ultrathin, multilayered polyelectrolyte films as nanofiltration membranes. Langmuir. 2003; 19:7038-7042.
72. Tang, C Y et al, Effect of membrane chemistry and coating layer on physiochemical properties of thin film composite polyamide RO and NF membranes. I. FTIR and XPS characterization of polyamide and coating layer chemistry, Desalination. 242 (2009). doi:10.1016/j.desal.2008.04.003.
73. Uludag-Demirer S, et al. Removal of ammonium and phosphate from the supernatant of anaerobically digested waste activated sludge by chemical precipitation. Bioresour Technol. 2009; 100: 3236-3244.
74. Uysal A, et al. The determination of fertilizer quality of the formed struvite from effluent of a sewage sludge anaerobic digester. J Hazard Mater. 2010; 181:248-254.
75. Wang R, et al. Fe(III) reduction and vivianite formation in activated sludge. Sep Purif Technol. 2019; 220:126-135.
76. Webb K. M., et al. Struvite (MgNH4PO4·6H2O) precipitation: potential for nutrient removal and re-use from wastewaters. In: Chemistry in Australia; 1995:42-44.
77. Wilfert P, et al. Vivianite as an important iron phosphate precipitate in sewage treatment plants. Water Res. 2016; 104:449-460.
78. Wilsenach, J A et al, Phosphate and potassium recovery from source separated urine through struvite precipitation, Water Res. 41 (2007), 458-466.
79. Wood, S et al, A review of greenhouse gas emission factors for fertiliser production, in: IEA Bioenergy Task, 2004: pp. 1-20.
80. Yang, Y H et al, Improving oxygen barrier and reducing moisture sensitivity of weak polyelectrolyte multilayer thin films with crosslinking, RSC Adv. 2 (2012). doi:10.1039/c2ra21845c.
81. Yaya F, et al. Assessment of the fertilizing effect of Vivianite on the growth and yield of the bean “Phaseolus vulgaris” on Oxisoils from Ngaoundere (central north). Int Res J Earth Sci. 2015; 3:18-26.
82. Yoon K, et al. High flux nanofiltration membranes based on interfacially polymerized polyamide barrier layer on polyacrylonitrile nanofibrous scaffolds. J Membr Sci. 2009; 326:484-492.
83. Yoshino M, et al. Removal and recovery of phosphate and ammonium as struvite from supernatant in anaerobic digestion. In: Water Science and Technology. Vol 48; 2003, 171-178.
84. Zhao, Y, et al, Fit-for-purpose design of nanofiltration membranes for simultaneous nutrient recovery and micropollutant removal, Environ. Sci. Technol. 55 (2021), 3352-3361.

What is claimed is:

1. A system for recovering ammonium and phosphorus from a waste stream, the system comprising:
(a) a first stage, wherein in the first stage, dissolved phosphorus is reacted with a ferrous salt to precipitate vivianite; and
(b) a second stage, wherein a nanofiltration membrane modified with one or more polyelectrolytes is present in the second stage for separation of ammonium.

2. The system of claim 1, further comprising a pre-filter to remove large particles from the waste stream.

3. The system of claim 2, wherein the filter comprises a 0.45 μm polyethersulfone membrane.

4. The system of claim 1, further comprising a means for separating and recovering the precipitated vivianite.

5. The system of claim 4, wherein the means for separating and recovering the precipitated vivianite comprises a filter, a magnet, or any combination thereof.

6. The system of claim 1, wherein the ferrous salt comprises ferrous sulfate heptahydrate.

7. The system of claim 1, wherein the second stage operates as a dead-end or a cross flow membrane filtration system.

8. The system of claim 1, wherein the one or more polyelectrolytes comprise poly(diallyl dimethylammonium) chloride (PDAC), poly(sodium 4-styrenesulfonate) (SPS), poly(allylamine hydrochloride) (PAH), poly(acrylic acid) (PAA), or any combination thereof.

9. The system of claim 1, further comprising sodium chloride in contact with the one or more polyelectrolytes.

10. The system of claim 1, wherein the one or more polyelectrolytes are present only on a first side of the membrane.

11. The system of claim 8, wherein the one or more polyelectrolytes comprise PDAC and SPS in alternating layers.

12. The system of claim 11, wherein an outermost layer of the alternating layers comprises PDAC and is positively charged.

13. The system of claim 11, wherein an outermost layer of the alternating layers comprises SPS and is negatively charged.

14. The system of claim 8, wherein the one or more polyelectrolytes comprise PAH and PAA in alternating layers.

15. The system of claim 14, wherein an outermost layer of the alternating layers comprises PAH and is positively charged.

16. The system of claim 14, wherein an outermost layer of the alternating layers is modified with glutaraldehyde to form a dense polyelectrolyte selective layer and decrease an amount of positive charge present on the outermost layer.

17. The system of claim 1, wherein the nanofiltration membrane comprises a support fabric, a porous layer having a first side in contact with the support fabric, and a polymer coating in contact with a second side of the porous layer.

18. The system of claim 17, wherein the porous layer comprises polyethersulfone, polysulfone, or any combination thereof; and wherein the porous layer has a thickness of about 50 μm.

19. The system of claim 17, wherein the polymer coating comprises polypiperazine, polyamide, or any combination thereof.

20. The system of claim 17, wherein the polymer coating has a thickness of less than about 200 nm.
